(19) United States
(12) Patent Application Publication
(10) Pub. No.: US 2026/0252139 A1
(43) Pub. Date: Aug. 27, 2026

(54) MOBILE DEVICE ENCLOSURE WITH INTEGRATED WIRELESS-TO-SERIAL BRIDGE

(71) Applicant: GCX Corporation, Petaluma, CA (US)

(72) Inventors: Bryan Rudolf Grziwok, Berkeley, CA (US); Adam Aronson, San Rafael, CA (US)

(21) Appl. No.: 19/545,456

(22) Filed: Feb. 20, 2026

Related U.S. Application Data
(60) Provisional application No. 63/761,340, filed on Feb. 21, 2025.

(51) Int. Cl. G06F 1/16; H04W 12/0471; H04W 76/14; H04W 4/80

(52) U.S. Cl. CPC G06F 1/1607; H04W 12/0471; H04W 76/14; H04W 4/80

(57) ABSTRACT

A mount apparatus and mobile applications use a Bluetooth-to-Serial bridge integrated within the device enclosure’s mounting area. The bridge can be powered by the mount, remaining separate from the mobile device’s charging/data connection. Via the tablet operating system, the Bluetooth link connects directly to applications on the device, streamlining communication among those applications, the mount, and any serial devices upstream. Using this separate channel for specialized hardware avoids competition for the physical port, preserving it for peripherals like card readers, receipt printers, and keyboards. Wired networking through an ethernet adapter, including receiving power over ethernet (PoE), is desirable where preferred. Additionally, the dedicated parallel communication channel established by the Bluetooth‑to‑Serial bridge, directly accessible by paired applications on the mobile device, can be extended to other specialized hardware with which the application may need to communicate, enabling flexible integration, reduced cabling contention, and improved system reliability across diverse deployment scenarios.

### CROSS-REFERENCE TO RELATED APPLICATION(S)

This application claims priority to application no. 63/761,340, filed February 21, 2025, which is application incorporated herein in its entirety by this reference thereto.

### TECHNICAL FIELD

Embodiments of the invention relate to a mobile device enclosure and associated docking mechanism and apparatus, for example, for supporting, charging, and communicating with tablet computers and other types of electronic equipment.

### BACKGROUND

A motorized docking apparatus serves to support and secure a mobile device or similar electronic equipment, nominally a tablet, and provide a portability feature by allowing authorized users to electronically unlock and undock the device enclosure from its mount. To control the unlocking feature from the tablet, it is necessary to establish a communication link between the software application running on the tablet and the mount. Such communication link ideally involves a wired interface between the device enclosure, i.e. the case in which the tablet is held and which docks to the mount, to ensure that an unlock command issued from the software application unlocks the mount to which the tablet requesting the unlock is docked.

In parallel with the need for a wired connection between the device enclosure and the mount, a variety of other peripheral equipment can also need to be connected to the tablet – such as keyboards, card readers, receipt printers, barcode readers, and the like – to provide other functions required by the application and use case. A mount with docking apparatus and its attendant peripheral equipment is referred to as a “station.” When a mobile device, enclosed in a device enclosure, is docked to the mount, the user expects all peripherals at that station to operate with the docked mobile device. For such a scenario, a wired connection for such equipment is desired. Mobile devices, tablets in particular, often have few ports for connection of wired peripherals. This can be addressed by the use of hubs, such as USB hubs, that connect multiple pieces of wired equipment to the same port. Such connection, such as for keyboards and network adapters, is highly standardized and supported by the mobile device at the system level.

Specialized hardware, such as the motorized docking apparatus, requires generic handling at the system level to make the connection with standard communication protocols and must also be made available by the operating system to the particular software application that interacts with the hardware. This can present barriers. The specialized hardware can compete with standard system-level peripherals for the physical port. Some mobile device manufacturers place burdensome authentication, hardware and software registration, and product review and acceptance requirements on specialized hardware that uses a physical, wired connection. Such responsibilities to the mobile device manufacturer make the development of hardware costly, time consuming, and risky.

### SUMMARY

To streamline communication between the mount apparatus and applications running on the mobile device disposed within the device enclosure, embodiments of the invention use a Bluetooth-to-Serial bridge incorporated within the mounting area of the device enclosure. The Bluetooth-to-Serial bridge can be powered by the mount, so that it is separate from the charging/data connection that serves the mobile device. The Bluetooth link connects via resources in the tablet operating system directly to software applications running on the mobile device, simplifying communication between those applications, the mount, and any serial devices connected upstream of the mount. The use of a Bluetooth connection to provide communication with software applications can avoid onerous costs and business risks imposed by some mobile device manufacturers on makers of devices that use wired connections for app-to-device communication. Terminating the Bluetooth link within the device enclosure and bridging to a wired connection across the mounting interface can also allow the tablet to determine and report definitively on the mount to which it has been docked. This definitive determination would not be possible if the tablet and mount were connected wirelessly because a tablet communicating wirelessly could not definitively know whether the mount with which it is communicating is the same as the one to which it is docked. In contrast, a tablet with a wired connection to the mount is assured that it is docked to the same mount with which it is communicating.

Use of a separate channel, e.g. the Bluetooth-to-Serial bridge, for specialized hardware such as the motorized docking apparatus also avoids competition for the physical port, leaving it free for peripheral equipment such as card readers, receipt printers, keyboards, and the like. Connection to wired networks, such as by ethernet adapter, and receiving power over ethernet (PoE), is also desirable in scenarios where that is preferred.

Additionally, a dedicated parallel communication channel created by the Bluetooth-to-Serial bridge which is directly accessible by software applications running on the mobile device that pair with it can be extended to other specialized hardware with which the application may need to communicate. One example of how to accomplish this would be for the mount electronics and software to emulate a USB host controller or USB device or both, ultimately forwarding communication upstream to the Bluetooth-to-Serial bridge and on to the software application. Another simpler but more proprietary method of extending communication access would be to offer direct serial connection to one or more ports on the microcontroller in the mount, without USB emulation. Notwithstanding the particular implementation, the extensibility to connect additional specialized hardware wired to the mount, with a wired interface across the mount-to-device enclosure interface, and to the software application via a Bluetooth-to-Serial bridge that is located in the device enclosure is an important feature of the disclosed system.

### BRIEF DESCRIPTION OF THE DRAWINGS

Details of one or more implementations of the subject matter described in this specification are set forth in the accompanying drawings and the description below. Other features, aspects, and potential advantages will become apparent from the description, the drawings, and the claims.

FIG. 1 illustrates an example of a device enclosure and associated mount.

FIG. 2 illustrates example components of a dock mount assembly.

FIG. 3 illustrates an example assembly of a device enclosure.

FIG. 4 illustrates an example components of an enclosure rear shell assembly.

FIG. 5 illustrates an example components of a mounting panel subassembly.

FIG. 6 illustrates example components of a dock mount assembly.

FIG. 7 illustrates example components of a magnet housing subassembly within a dock mount assembly.

FIG. 8 illustrates a cross-section of an example mount and device enclosure.

FIG. 9 illustrates an example docking apparatus.

FIG. 10 illustrates an exploded view of an example pivoting neck assembly in exploded view.

FIG. 11 an example docking mount housing assembly in exploded view.

FIG. 12 an example magnet housing assembly in exploded view.

FIG. 13 illustrates a view of an example printed circuit board (PCB) assembly.

FIG. 14 illustrates an example motorized locking mount assembly in exploded view.

FIG. 15 illustrates an example network topology for motorized locking mounts.

FIG. 16 diagrams the locking and unlocking sequences of an example motorized locking mechanism.

FIG. 17 illustrates an example detailed view of an example motorized locking mechanism in the unlocked neutral position.

FIG. 18 illustrates an example detailed view of an example motorized locking mechanism in the locked neutral position.

FIG. 19 illustrates an example detailed view of an example motorized locking mechanism in the key lock position.

FIG. 20 illustrates an example detailed view of an example motorized locking mechanism in the key unlock position.

FIG. 21 illustrates an example detailed view of an example motorized locking mechanism in the motor unlock position.

FIG. 22 illustrates an example detailed view of an example motorized locking mechanism in the motor lock position.

FIG. 23 is a wire diagram describing the components and communication flows of the disclosed system in schematic form.

FIG. 24 is a block diagram that illustrates an example of a computer system in which at least some operations described herein can be implemented.

Like reference numbers and designations in the various drawings indicate like elements.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Embodiments of the invention relate to a docking mechanism and apparatus, and specifically to a docking mount suited for use in supporting electronic equipment, including tablet computers. One embodiment of wireless communication is Bluetooth communication. The Wireless-to-Serial (W2S) bridge is located in the mounting portion of the device enclosure. This disclosure also describes various methods for delivering power and data to the docking apparatus, the bridge, and the electronic equipment contained within the device enclosure.

A “Bluetooth-to-Serial bridge” (B2S bridge) is an implementation of a wireless bridge and refers to an electronic device comprising a Bluetooth radio and a microprocessor that runs software to implement a two-way conversion between Bluetooth and serial communication protocols. The microprocessor receives inbound communication at the serial port, encapsulates it for Bluetooth transmission, and transmits the resulting data packets over the Bluetooth link. Likewise, inbound Bluetooth packets are parsed and resulting data sent out via the serial port.

The incorporation of a Bluetooth-to-Serial bridge within the mounting portion of the device enclosure provides several advantages over the customary wired-only or Bluetooth-only communications links that may otherwise be used.

Implementing a wired-only communication link between the mount and the tablet exposes the manufacturer of accessory hardware to substantial burdens and business risks. These burdens are imposed by specific manufacturers of mobile devices, including tablet computers, and include:
1) Mandatory registration in approved manufacturer programs, use of prescribed communication protocols, purchase and use of proprietary electronic components including device authentication chips and device-specific connectors, manufacturer review and approval of physical pre-production hardware as a condition of obtaining said proprietary electronic components, manufacturer review and approval of suppliers and inventory practices, and joint registration of approved hardware with specific software applications as a device manufacturer requirement for publishing of software applications.
2) Additionally, ongoing program enrollment, reporting, and maintenance requirements, as imposed by certain mobile device manufacturers, creates the risk that the mobile device manufacturer could suspend or revoke approval of an accessory, limit access to needed authentication chips, and disrupt ongoing hardware production. Joint registration of software applications to accessory hardware also creates the ongoing risk that approvals for new software releases and even support for software applications and device hardware already produced and in the field could be unilaterally withdrawn by the mobile device manufacturer.
3) The device authentication chips required by certain mobile device manufacturers are costly and subject to large lead times and large minimum order quantities, resulting in substantial inventory cost and production schedule risks.
4) The device authentication chips and communication protocols required to comply with mobile device manufacturer requirements are specific to that mobile device manufacturer and are not compatible with the mobile devices produced by other manufacturers, thus increasing the cost and risk associated with supporting other mobile devices or developing cross-platform accessories.

The burdens described above add substantial business risk to the development of accessory hardware that wires directly to the mobile devices of certain manufacturers that impose them.

One way around the risks and burdens associated with wired communication is to communicate wirelessly. Device manufacturers who require special authentication for wired hardware accessories do allow wireless communication, specifically Bluetooth, between a software application and a paired accessory.

For the specific application of a device enclosure which docks and undocks with one or more mounts, Bluetooth-only communication directly between the tablet and the dock would pose some problems:
1) In an arrangement where one or more device enclosures will dock interchangeably to a plurality of mounts, each tablet would have to maintain pairings with each mount with which it could dock. This would create a geometrically expanding array of pairing requirements as the number of tablet enclosures and mounts that interoperate increases. Such a scenario is not reasonable nor practical for a person to use or maintain.
2) For the specific application of device enclosures that dock interchangeably to a plurality of mounts, use of wireless-only communication would also prevent the application running on the device from knowing on which mount it was docked. For example, if the application is paired and communicating with one mount, but is docked to another mount, whether also paired to the other mount or not, the application or the device has no easy way to definitively determine to which mount it is docked. It is conceivable to make each device enclosure unique in some way, such as with a unique-value resistor or electronic UDID (universal device ID) embedded in the enclosure that is read by the mount when the enclosure is docked. But such a solution would be complex, require registration of that UDID within the app, and would require that each enclosure be paired with all mounts so that an application can “find” its UDID among those being broadcast by mounts to which it might be docked.

A wired connection between device enclosure and mount solves the difficulties of wireless-only communication described above because the direct electrical connection allows the application to definitively identify to which mount the enclosure is docked.

Furthermore, the mount, as described herein and in US10176651, comprises a microprocessor (MCU) which has within it a programmatically available UDID. If the mount UDID is registered in a database or lookup table that is available to the application running on the tablet and communicating with the mount then the application can definitively identify the mount to which the its device enclosure is docked.

Using a Bluetooth-to-Serial bridge, and embedding that bridge within the mobile device enclosure, elegantly avoids the costs and burdens of a direct wired connection to the mobile device, while meeting the system design requirements that a software application be able to definitively and programmatically identify the mount to which its device enclosure is docked.

Embedding the B2S bridge within the device enclosure creates a one-to-one relationship between the device and its enclosure. This makes it intuitive for the user when pairing the device and its enclosure during setup: each tablet need only pair with its own enclosure, then the tablet can be secured within that enclosure and setup is complete.

Embedding the B2S bridge within the device enclosure also protects it from tampering. The location of the B2S bridge within the mounting flange of the device enclosure prevents the Bluetooth pairing button from being accessed once the mobile device, e.g. tablet, is installed into the device enclosure. The Bluetooth connection between the mobile device and B2S bridge can also be bonded. A “bonded” Bluetooth pairing means that the connection is encrypted, secure, and exclusive. In this example, the B2S bridge can bond with only one mobile device at a time. A bonded pairing retains its encryption keys and can use them to automatically reestablish communication if it fails.

The only ways bonding can be cleared is by 1) pressing the pairing button on the B2S bridge, 2) clearing pairing within the software application, or 3) clearing the Bluetooth device connection in mobile device settings.

As noted, the location of the B2S bridge within the mounting panel of the device enclosure blocks access to the pairing button when the tablet is secured within the enclosure. So the same physical security measures that protect the tablet inside the device enclosure also prevent access to the pairing button on the B2S bridge and tampering with the Bluetooth connection.

Tampering with the secure bonded pairing connection from the software connection or device settings can be prevented by requiring security credentials, such as password or biometric identification, for access to device settings or to the pairing functionality of the software application.

An important consideration of this architecture is how power and data are connected to the mobile device and how power and data are connected to the B2S bridge. For the disclosed implementation, power and data for the mobile device is kept separate from that supplied to the mount and the B2S bridge.

In the preferred embodiment, two power/data cables extend from the base of the mount. One cable, which can incorporate a USB-C connector, provides dedicated mobile device charging and data. The cable connects directly to the mobile device and can support, for example, direct USB-C PD charging between a power source connected below the mount and a mobile device connected inside the device enclosure. That the connection between the power supply is direct, and not shared between the mobile device and the docking apparatus or B2S bridge, is important because USB-C PD specifications, for example, require negotiation between source and sink directly, and no intermediate power consumption beyond cable losses is permitted. Accordingly, providing a dedicated charging/data connection for the mobile device facilitates the most flexibility in how the mobile device is charged, including the cost-effective option of using the power supply provided with the mobile device, and how other peripherals might be connected to it.

The second power/data cable extending from the mount connects to the mount electronics. These electronics may comprise a motorized locking apparatus as described in US10176651, which is incorporated by reference, and also comprise a microcontroller (MCU) which is used to operate the motorized locking apparatus and to communicate with the software application running on the mobile device via the B2S bridge. The MCU can also forward communication from other peripheral devices and sensors connected to the second power/data cable directly to the connected software application running on the mobile device via the B2S bridge.

The second power/data cable, nominally incorporating a USB-A connector, also provides power across the mount/enclosure interface to the B2S bridge disposed in the mounting panel of a device enclosure that is docked to the mount which the cable powers. This is an important part of powering the B2S bridge independently of the tablet. Powering the B2S bridge only when it is docked to a mount is also a natural arrangement, as the function of the B2S bridge to bridge Bluetooth to wired serial is only relevant when the wired serial connection is also in place. This condition is only met when the device enclosure is docked to a compatible mount.

Implementations of the subject matter described here can provide one or more of the following potential advantages. A Bluetooth-to-Serial bridge can provide a communication interface between a mounting apparatus and a software application running on the electronic device disposed within the device enclosure. The communication interface so provided can avoid many business risks and costs. The communication interface so provided can allow the application to definitively identify to which mount the enclosure is docked. The communication interface so provided supports the definitive identification between the mobile device and mount through secure bonded pairing between the mobile device and the B2S bridge disposed within the device enclosure, which bonded pairing is protected both physically and through software security measures and through the definitive aspect of the wired connection between the electrical contacts on the serial port of the Serial bridge, as directly connected across the interface between the mount and the device enclosure.

The subject matter described herein also provides potential advantages in how power and data are delivered to the mobile device and how power and data are delivered to the docking apparatus and B2S bridge. By isolating the charging/data connection to the mobile device, the embodiment described here facilitates connection of the most varied assortment of power adapters and device-level peripherals, including keyboards, keyboard wedge devices, pointing devices, ethernet adapters, storage devices, as well as USB hubs to facilitate connection of multiple peripheral devices in conjunction with delivery of power for tablet charging. A second cable similarly isolates the power/data connection to the docking apparatus and B2S bridge, which facilitates providing and powering the communication link between the mount and the software application on the mobile device when a device enclosure paired with the mobile device is docked to the mount. Such communication between the software application and the dock can include any devices connected to the mount, and on to the device enclosure and software application running on the mobile device, via this second cable. The second cable can, for example, use hardware converters and/or software emulators to implement a COM port via the USB-A connection. This connection allows devices so connected to communicate directly with the target application on a mobile device, and to do so interchangeably with any device enclosure that is docked to the mount and to which the B2S bridge comprised within the device enclosure such mobile device is paired.

In combined effect, the B2S bridge, as taught here, provides a separate communication channel, nominally a serial communication channel, which is direct-wired for devices connected to the mount, which communication channel connects directly to software applications running on the mobile device (based on which application is paired with the B2S bridge) without the need for costly proprietary components or adherence to burdensome, restrictive, and risky requirements of device manufacturer accessory hardware developer programs, and without the restrictive hardware and software approvals required by certain mobile device manufacturers.

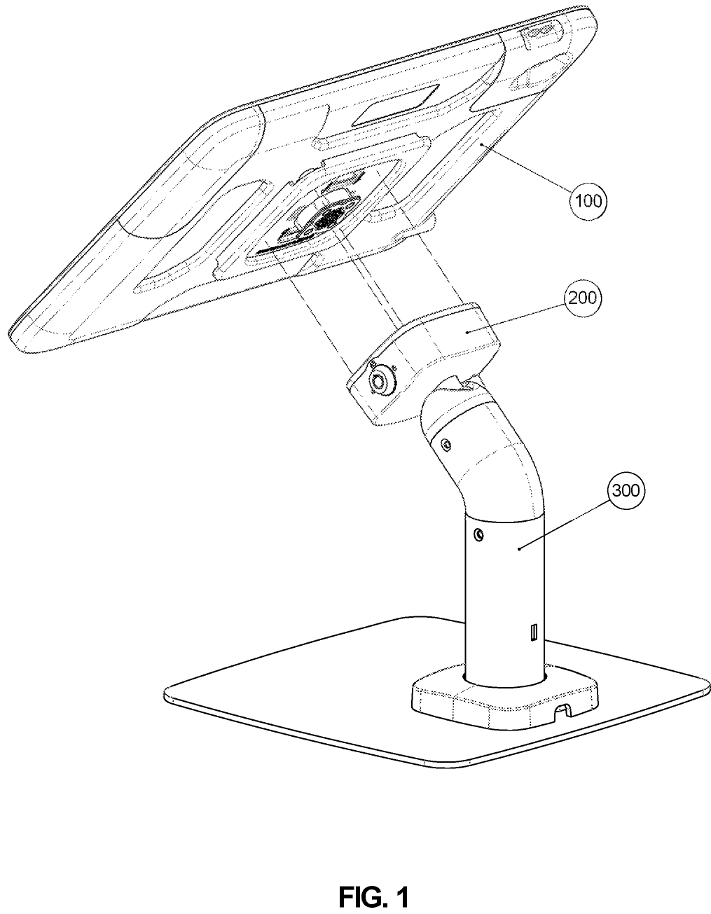

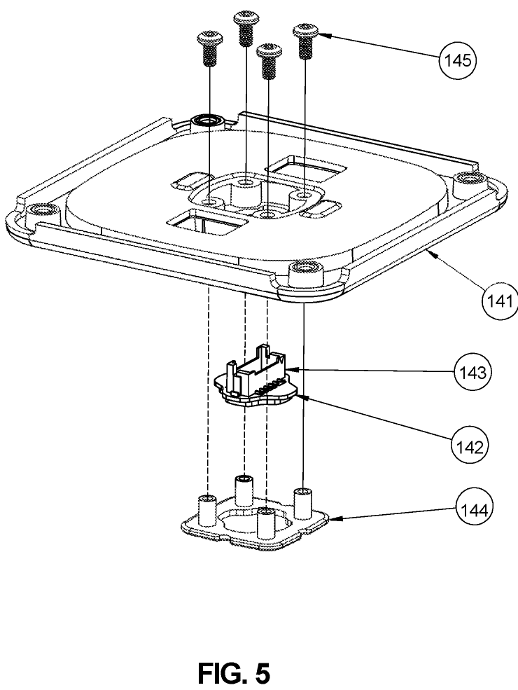

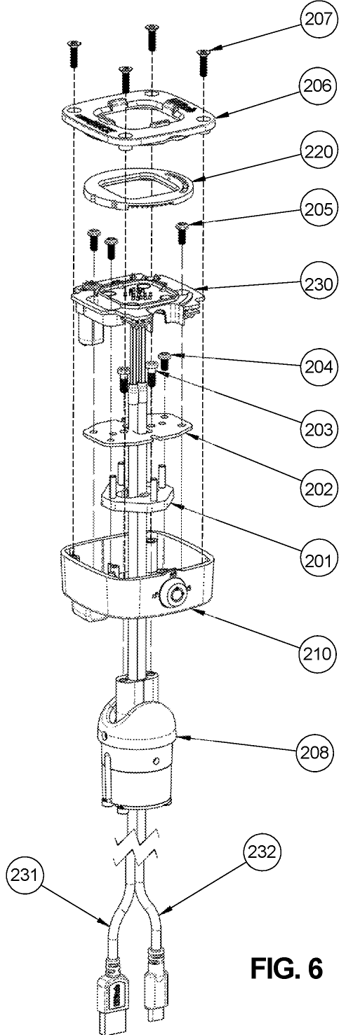

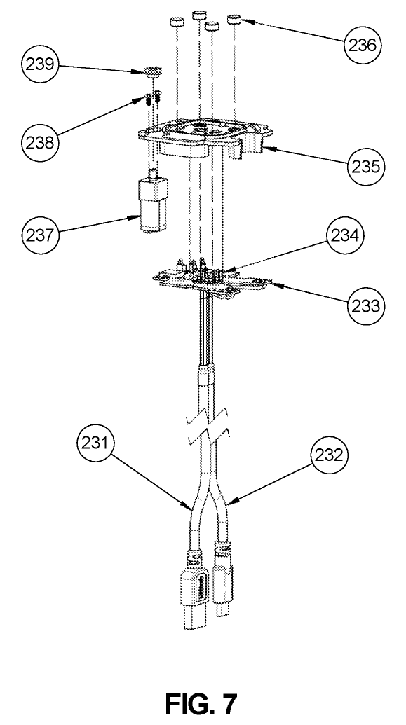

FIG. 1 illustrates an example of a docking apparatus, which, in some implementations, can be a complete apparatus that includes the components described here. The apparatus is to allow the device enclosure 100 to dock removably to a mount 200 which may also comprise a support structure. In some implementations, a mount can be a fixed portion of the docking apparatus, for example, fixedly secured to a surface such as a floor or wall or be supported by a base, for example a weighted base. While the mount can include a pole for ergonomic positioning in some implementations, it may not in other implementations. The mount 200 may be disposed at the end of a support structure. Cabling which extends from the mount (not shown) deliver power and/or data to the mount. The device enclosure comprises a mounting plate (144, FIG. 5) which can be securely captured and held in place when the ring assembly (220, FIG. 6) rotates to the locked position, either by the action of a manual key lock or driven by the motor (237, FIG. 7).

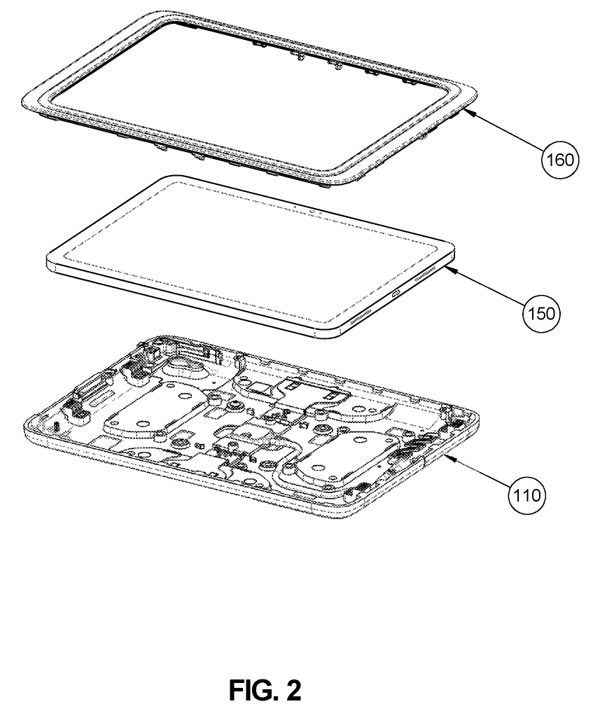

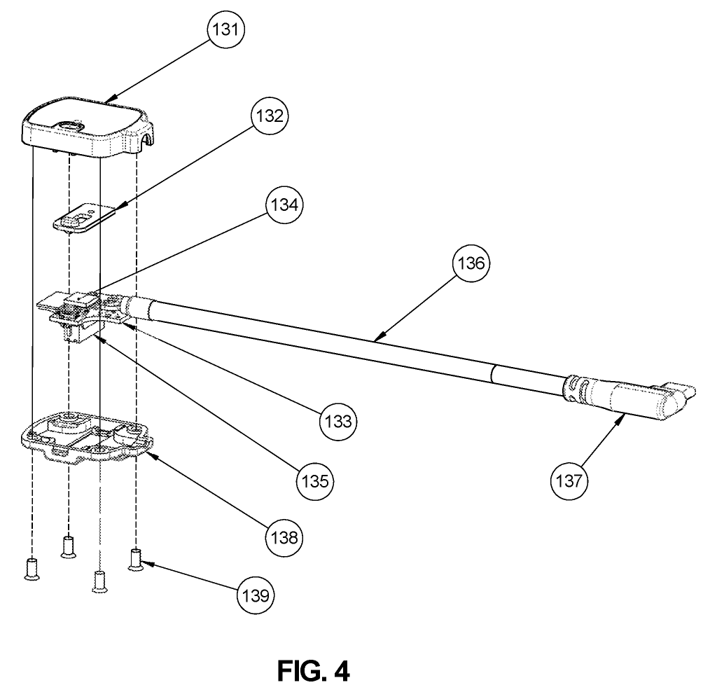

FIG. 2 illustrates an example assembly of a device enclosure. The mobile device 150 is placed into the rear housing assembly 110, and then the faceplate snapped into place over the mobile device. Cable 136 lays within the rear housing and comprises a connector 137 (see FIG. 4). When installing the mobile device 150 into the device enclosures, the connector 137 can be plugged into the mobile device 150 to deliver charging power and data.

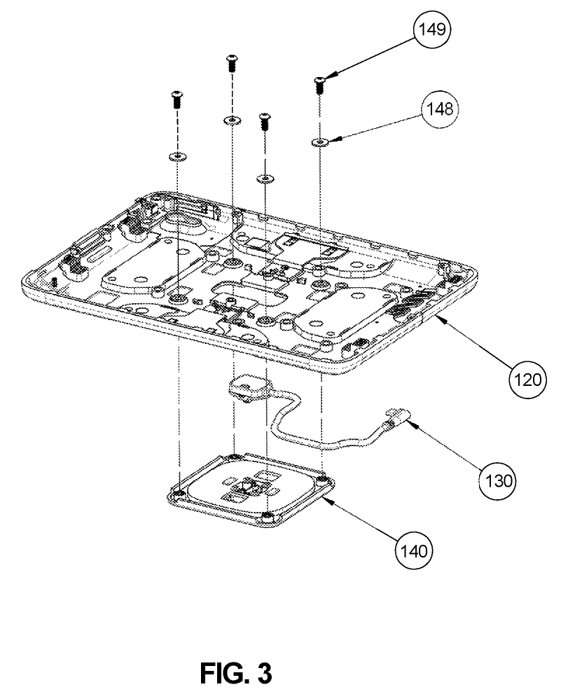

FIG. 3 illustrates assembly of a mount panel assembly 140 to the rear shell 120 of the device enclosure, capturing and enclosing the interconnect module 130. To make the assembly, the B2S bridge is connected to the interface board in the mount panel assembly (see FIG. 5), then the cable routed into the rear shell of the device enclosure. The mount panel assembly is secured to the rear shell using washers 148 and screws 149. FIG. 3, along with FIG. 2, show the explicit and specific mounting location of the B2S bridge within the mounting area of the device enclosure.

FIG. 4 illustrates components of an interconnect module. The B2S board 133 comprises a Bluetooth module 134 with integrated radio and microcontroller. The pairing button 132 operates a switch on the B2S board which can initiate a pairing process. The board-to-board connector 135 brings two sets of connections from the interface board (142, FIG. 5) to which it is mated. One set of connections supports mobile device charging and data and passes through the interconnect board 133 to the internal cable 136 and connector 137, which connector connects to the tablet’s charging/data port. The connector 137 can be any appropriate connector, such as USB-C, MicroUSB, or proprietary connectors. The cable 136 can have the appropriate specification and number of wires to properly support the connection requirements. A second set of connections passed from the interface board (142, FIG. 5) to the interconnect board 133 via the board-to-board connector 135 delivers power and wired serial communication to the Bluetooth module 134. When paired, the Bluetooth module 134 communicates wirelessly with the Bluetooth module in the mobile device. The interconnect module is assembled by enclosing the interconnect board 133 within the top housing 131 and bottom housing 138 and securing the housing parts with screws 139.

FIG. 5 illustrates components of a mount panel assembly. The mount panel assembly comprises a mount panel 141, mounting plate 144, and interface board 142, which interface board further comprises a board-to-board connector 143. The mounting plate is secured to the mount panel by the use of screws 145, capturing the interface board in the process. The function of the mount panel is to provide both secure mechanical attachment via the mounting plate and electrical connection via the interface board for the device enclosure 100.

FIG. 6 illustrates components of a dock mount assembly. The mount is assembled by routing cables 231 and 232 up through the pivot joint 208, if present, mount housing assembly 210, neck plate 201, and internal mount plate 202. The neck plate 201 is captured to the mount housing assembly 210 by the internal mount plate. If the pivot joint 208 is present, screws 203 secure the pivot joint to the internal mount plate and screw 204 may secure a corner of the internal mount plate to the mount housing assembly 210.

Having been passed through the components so far described the wires of the cables 231 and 232 can be attached by connector or direct soldering to the mount board (233, FIG. 7). After attaching the wires, the mount board is heat staked to the underside of the magnet housing (235, FIG. 7), and the motor, motor pinion and magnets assembled to create the magnet housing assembly 230. See below and FIG. 7 for further illustration of an example magnet housing assembly.

The magnet housing assembly 230 is then secured into the mount housing assembly 210 with additional screws 205, which clamp and secure the mount plate 202 and neck plate 201 in the process. The lock ring assembly 220 is then set into place, with gear teeth meshing with the gear teeth on the lock pinion and motor pinion. Finally, the mount cover 206 is placed over the lock ring assembly 220 and secured with four screws 310. The mount cover may be greased prior to assembly. The components in this assembly may be assembled in an order different from that described above, different fasteners may be used, and any type or shape of mounting apparatus, including but not limited to, a ball-in-socket joint, may be used.

FIG. 7 illustrates components of a magnet housing assembly. First magnets 236 are preassembled into the magnet housing 235. Separately, cables 231 and 232 are attached to the mount board 233, either by connector or direct soldering. The mount board is then heat staked to the underside of the magnet housing 235, such that the spring pins 234 protrude up through the magnet housing. The motor 237 is attached to the magnet housing 235 with screws 238, and the motor pinion 239 mounted to the motor shaft.

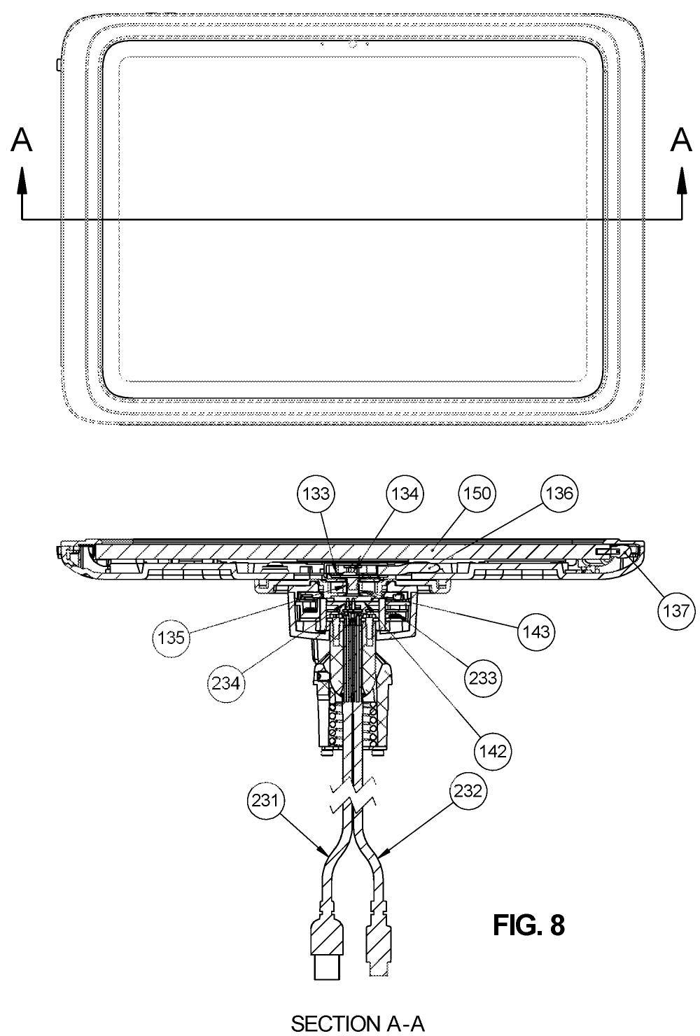

FIG. 8 illustrates a cross section of an example device enclosure docked to an example mount, showing the relative positioning and interconnection of the components involved. Cable 232 is dedicated to tablet power and communication. It terminates on the mount board 233. On the mount board, the connections are routed directly to spring pins 234. When the device enclosure 100 is docked, conductive pads on the interface board 143 come into contact with the spring pins 234. From the interface board, a mating pair of board-to-board connectors 143 and 135 conduct the connections to the interconnect board 133. Within the interconnect module 130, an internal cable 136 is connected to the interconnect board 133, terminating in a connector 137 appropriate for the mobile device 150 for which the device enclosure is configured. The connector 137 connects to the primary power/data connection on the mobile device. Separate from cable 232, cable 231 is dedicated to power for the mount and bridge electronics, and to communication between the mount, bridge, and the software application running on the mobile device. As with cable 232, cable 231 routes up through the mount 200 and terminates on the mount board 233. Cable 232 delivers power to the mount electronics, to run the microprocessor and motorized dock/undock function, if present.

On the mount board, power from cable 232 and data connections from the UART (serial) port on the mount board processor are also are routed to spring pins 234 at the mount/enclosure interface, which spring pins are separate and distinct from the spring pins to which cable 231. When the device enclosure 100 is docked, conductive pads on the interface board 143 come into contact with the spring pins 234. From the interface board, a mating pair of board-to-board connectors 143 and 135 conduct the connections to the interconnect board 133. Within the interconnect module 130, the power and serial data on this second channel are routed to the serial port of the Bluetooth module 134. From the Bluetooth module, the serial data is transmitted wirelessly to the mobile device 150, and specifically to the software application with which the Bluetooth module is paired.

### Alternative Implementation

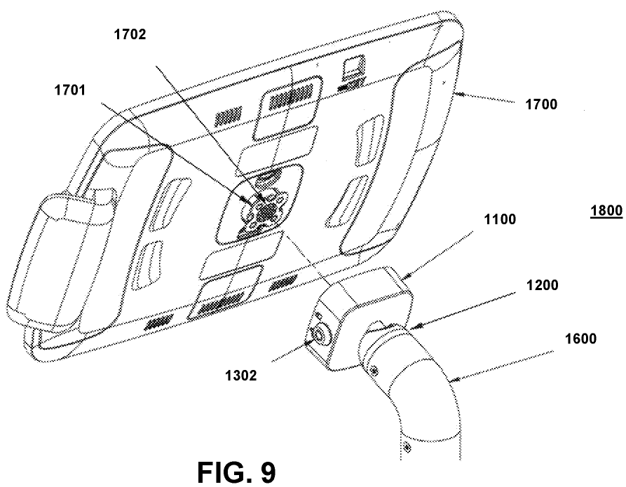

The B2S bridge as described with reference to FIGS. 9-22 can be implemented in a docking mechanism and apparatus, which includes a docking mount suited for use in supporting electronic equipment, for example, a tablet computer or other device. An example of the docking mechanism and apparatus described here are described below with reference to FIGS. 9-22. Specifically, this following discussion describes the incorporation of a Wireless-to-Serial bridge that can be implemented with the docking mechanism and apparatus described below with reference to FIGS. 9-22.

Such a docking apparatus is described below with reference FIGS. 9-22. The docking apparatus described below includes a docking mount and a mounting post for mounting the electronic equipment. In some implementations, the docking mount includes a lock plate. The lock plate can be driven by a mechanism. The mechanism can involve both motorized and manually driven components. The manually driven component of the mechanism can be driven by a key ring and key pinion attached to the mandrel of a locking unit, such as a standard tubular lock. The motorized component of the mechanism can be driven by a motor ring and motor pinion attached to the output shaft of a motor, with or without gearbox reduction, which motor is in turn controlled by a microcontroller. The mechanism can be a planar rotating mechanism which includes overlapping rings. The rings can be driven by the motor pinion and the key pinion respectively. The rings can be designed so that the movement of each ring does not interfere with the other. As it rotates, the lock plate captures the corners of a mounting plate located on the back of the electronic equipment being docked, thus securing the equipment to the docking mount. The docking mount further comprises a housing to house the lock plate, motor, locking unit, mechanism, and associated electronics. The planar nature of the docking mechanism allows the docking mount to be compact, while cleanly enclosing all moving parts.

Some electronic equipment, for example a tablet computer, does not have adequate onboard battery life to stay powered for a full day of use. A powered docking interface can address this need by supplying mains power to the docked electronic equipment. Furthermore, it can be beneficial to pass data, such as through a Universal Serial Bus (“USB”) connection, to the electronic equipment to facilitate the operation of peripheral equipment that may be connected to the electronic equipment. The subject docking apparatus facilitates transmission of both power and data from the docking mount to the electronic equipment. This transmission of power and data is unaffected by the relative orientation of the docking mount and the docked electronic equipment. The docked equipment may be mounted to the docking mount in any of four primary orientations, e.g. portrait, landscape, inverted portrait, and inverted landscape, and the docking mount itself mounted at any angle or orientation, without negative impact to the function of the electrical connections.

The docking apparatus produces a mounting interface that includes a tight mechanical connection between the docked equipment and the docking mount. This tight mechanical connection is facilitated by an arrangement of progressively tighter lead-ins and alignment details. The mounting interface that results is beneficial both for ensuring good electrical contact and allowing mechanical forces to be transmitted through the mounting interface without looseness or wobbling. The arrangement of lead-ins and alignment details, in combination with the locking plate, are suited to transmit mechanical forces created by manipulation of the docked equipment across the mounting interface. In some embodiments, manipulation of the docked equipment includes pivoting and rotating the equipment.

In some embodiments, the docking assembly includes magnets at the mounting interface fixed to the housing. The magnets attract the mounting plate fixed to the electronic equipment into tight alignment with the docking mount and support at least a portion of the weight of the equipment. In some embodiments, the user can leave the tablet on the mount without concern that the mounting plate disengages with the docking mount, which allows the user to use both hands, if needed, to operate the lock. In some embodiments, electrical connections between the docking mount and the electronic equipment function as the magnets retain the equipment in the docking mount, regardless of whether the mount is locked or not.

In some embodiments, the mounting plate, pinion, locking unit, and lock plate are of metal material, and the housing is of plastic, facilitating an optimal balance of mechanical strength and economic manufacture. In other embodiments, the mounting plate, pinion, locking unit, lock plate, housing, and other elements of the docking mount are of a different material or materials. In certain embodiments, the elements of the docking apparatus are made with associated manufacturing methods, including die casting, injection molding, and stamping from aluminum, zinc, steel, plastics, composite materials, and glass/fiber reinforced plastics.

Certain embodiments of the docking apparatus can provide one or more of the following potential advantages. The docking apparatus can allow the docked electronic equipment to be secured to and removed from the docking mount by use of a standard tubular key. The docking apparatus can also incorporate a motor, which can be configured to secure the docked electronic equipment automatically to the docking mount when the mounting interface is engaged with the docking apparatus. The motorized aspect of the docking apparatus can be configured to release the electronic equipment from the docking mount by use of an electronic signal. The release signal can consist of a transmission from the docked electronic equipment, such as a tablet computer. The transmission of a release signal may be initiated by the authentication of an access credential through a user interface provided on the tablet computer or other electronic equipment.

The motorized aspect of the system can include a motor disposed on a second axis parallel to, and offset from, the first, central axis about which the lock place rotates. The motor can include an output shaft which lies along the second axis, and to which a motor pinion is mounted. The pinion can be configured to cause a motor ring to rotate about the first axis. The motor ring can be configured to cause the locking plate to rotate in to a locked or unlocked position, depending on the direction in which the motor is driven.

The system may also include a key-operated locking unit connected to the housing. The locking unit includes a lock pinion configured to be rotated on a second axis that is perpendicular to the first axis. The key pinion is configured to rotate in response to a rotation of the locking unit using the key. The key pinion can be configured to cause a key ring to rotate about the first axis. The key ring can be configured to cause the locking plate to rotate to a locked or unlocked position, depending on the direction in which the key is turned.

The system includes a lock plate configured to be received in the housing between the first surface and the second surface. The lock plate is configured to receive a finger of the motor ring such that it is driven to rotate about the first axis in response to the rotation of the motor ring. The lock plate can also receive a finger of the key ring such that it is driven to rotate about the first axis in response to the rotation of a key in the locking unit. The lock plate can comprise a slot such that the motion of the lock plate in response to either the motor ring or the key ring does not cause interference with the opposite ring. The system also includes a rear housing configured with an attached mounting plate, which mounting plate is captured by the lock plate when the docking apparatus is locked, and which mounting plate is released by the lock plate when the docking apparatus is unlocked. The rear housing can be a portion of a case which is configured to receive a tablet computer. The rear housing can be a portion of an electronic device housing directly.

The mount can further comprise a circuit board with a microcontroller which is configured to control the motor and to communicate with the tablet computer. The tablet computer can be configured with a software application that can communicate with the microcontroller on the mount. The software application can further be designed to receive as input an access credential which may, for example consist of one or more passwords, PINs (personal identification number), biometric information items such as fingerprints, and/or images such as barcodes, QR codes, or other images. The software application can be designed to authenticate the access credential or credentials, and if valid, communicate with the microprocessor in the attached mount to operate, either lock or unlock, the motorized locking mechanism in that mount.

One or more tablets operating a software application which communicates with one or more mount to which each tablet is docked can communicate electronically with a network-based database and administration software. The administration software can be configured to collect system data in the database. The database information can be indexed by timestamp and unique mount ID number. The information can include data relating to the mount, including availability of mains power, lock/unlock status, mount ID, head present status, as well as other data which may be available. The information can also include data relating to the tablet, including apps in operation, app-specific data, tablet ID, charging status and battery charge level, as well as other data which may be available. The information can also include data related to password authentication, including usernames, passwords, encryption keys, as well as other data which may be available. All information may be transmitted in either plain text or encrypted format, or a combination of formats. The administration software can be configured to gather and analyze collected data for the purpose of monitoring and maintaining the network of installed kiosks and to administer associated user accounts at the network level.

In its various embodiments, the subject docking apparatus yields a load-bearing, secure, detachable mount that provides power and data connection to the electronic device. In all embodiments disclosed, the docking apparatus includes an arrangement of lead-ins, guide features, electrical connections, and locking plate, and allows the alternate and non-conflicting use of both a standard key lock and an electronic signal transmitted from the electronic device, i.e. a tablet computer, to operate the docking apparatus.

The electrical connections are capable of providing power and data connection, for example USB, in any of four primary orientations (portrait, landscape, inverted portrait, and inverted landscape).

The combination of generally square geometry of the mounting interface and patterned contact pads in the electrical connection is especially suited to the mounting of electronic equipment, for example tablet computers, because it allows the electronic equipment to be docked in one of four orientations, e.g. at 90-degree increments. For example, because tablet computers generally feature a self-orienting display, this flexibility in docking orientation allows the positioning of the tablet’s camera and other features of the enclosure in any desired orientation without compromising the user interface.

The docking apparatus can allow power and signals, e.g. data, to be passed through the mounting interface. The docking apparatus can allow the docked electronic equipment to be mounted in any orientation, for example, portrait, landscape, standard, inverted, and/or other. The mounting interface can facilitate manipulation of the electronic equipment without looseness or wobbling, and provide physical security to the electronic equipment. The docking apparatus can use a magnetic attachment scheme with the magnets to support the electronic equipment conveniently whether the docking mount is locked or not. The docking apparatus can feature a static, i.e. non-moving, electrical interface, which is more reliable and durable than a wiping interface. The docking apparatus can be designed to be cost-effectively mass produced.

FIG. 9 illustrates an example docking apparatus 1800 in which the features described with reference to FIGS. 9-22 can be incorporated. The example docking apparatus 1800 allows an enclosure housing 1700 comprising the docked electronic equipment to removably mount to a mounting post 1600 via the docking mount 1100. In some implementations, the docking mount 1100 is fixedly secured to a surface, for example a floor or wall, or is supported by a base, for example, a weighted base. In some embodiments, the docking mount 1100 includes a pole extending from a side of the docking mount for ergonomic positioning. In other embodiments, the docking mount 1100 does not include the pole.

In some embodiments, the docking mount 1100 is disposed at the end of the mounting post 1600. The mounting post 1600 supports the docking mount 1100 at a specific height, securing the docking apparatus 1700 from theft, and delivering power and/or data via an electrical connection, or cable, to an electrical interface in the docking mount 1100. When the enclosure housing 1700 is mated with the docking mount 1100, an electrical connection is made between the electrical interface in the docking mount 1100 and an electrical interface 1702 disposed within the mounting flange 1701.

In some embodiments, the mounting flange 1701 may comprise a plate bonded or otherwise mounted to a surface of the docked electronic equipment.

In some embodiments, the mounting flange 1701 can be incorporated directly into the housing of the docked electronic equipment. The enclosure housing 1700 includes one or more features, such as mounting flange 1701, that mate with the docking mount 1100. The mounting post 1600 may consist of a tubular post with a circular cross-section as shown. In other embodiments, the mounting post 1600 is of a different suitable structure, with a different cross-section, or both.

In some embodiments, the docking mount 1100 fixedly mounts to the mounting post 1600 or pivotally mounts with an interposed pivot joint 1200. The enclosure housing 1700 may be locked to the docking mount 1100 by the locking unit 1302, for example, with a key lock. The enclosure housing 1700 may also be locked to the docking mount 1100 by a motorized locking mechanism. The motorized locking mechanism may be used in combination with the key lock, and the mechanism can be designed such that the action of the motor and the key do not conflict. The motorized locking mechanism may be designed to lock the docking mount 1100 automatically when the enclosure housing 1700 is mated to it. The motorized locking mechanism may be designed to lock or unlock when it receives an electrical signal. The electrical signal to operate the motorized locking mechanism may be generated by a software program operating on electronic equipment inside the enclosure housing 1700, for example a tablet computer. The software program may be designed to receive input of a password or access code to trigger operation of the motorized locking mechanism. The software program may be designed to recognize an image, such as a barcode, QR code, or other image, to trigger operation of the motorized locking mechanism. The software program may be designed to recognize a radio signal to trigger operation of the motorized locking mechanism.

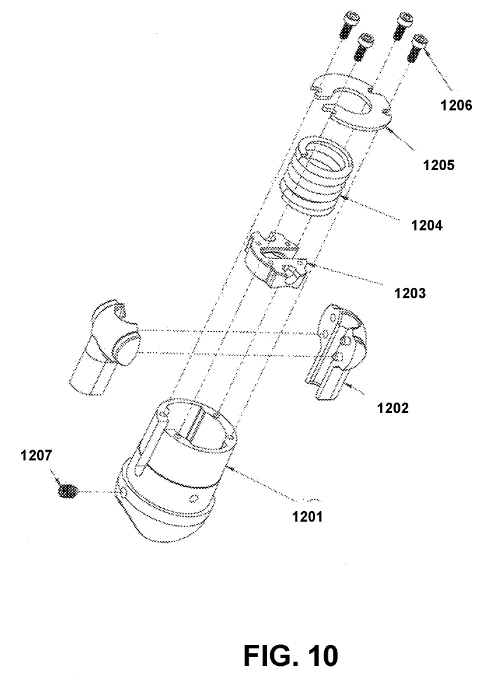

FIG. 10 illustrates an exploded view of an example pivoting neck assembly 1200. The docking mount 1100 may optionally include example pivoting neck assembly 1200 of FIG. 10. The pivoting neck assembly 1200 includes a socket 1201. A two-part ball 1202 is assembled around one or more cables, for example cable 1101, and installed into socket 1201. Cup 1203 is placed into socket 1201 behind two-part ball 1202. Spring 1204 is placed into the assembly behind cup 203 and held in compression by spring plate 1205 and screws 1206. The force generated by the compressed spring creates stiffness in the pivoting neck assembly 1200, allowing it to support the weight of items mounted to it, for example enclosure housing 1700 and any associated equipment. Set screw 1207 can be screwed into socket 1201 and tightened against two-part ball 1202 to stiffen or lock completely the movement of the pivoting neck assembly 1200. The two-part ball 1202 may be greased for smooth operation and reduced wear over time. The use of a two-part ball allows the assembly to be compact and still pass complete cables, which may include larger over molded connectors. The size of cable over molds which is usable with this configuration is limited only by the size of the mouth of socket 1201.

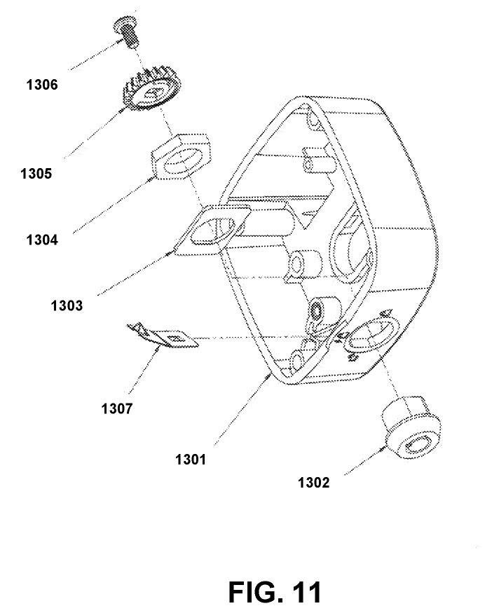

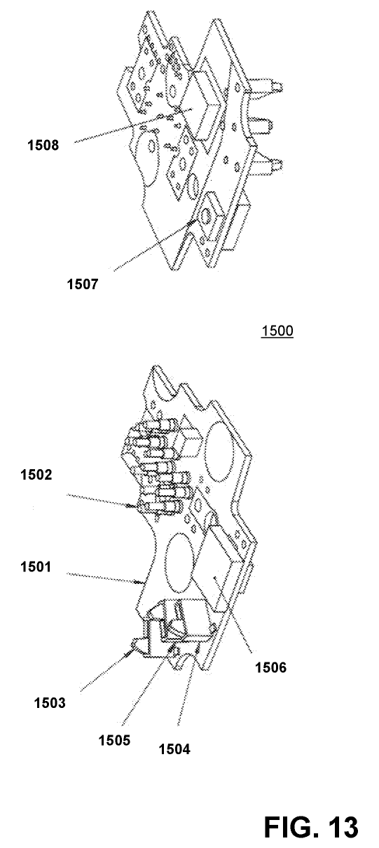

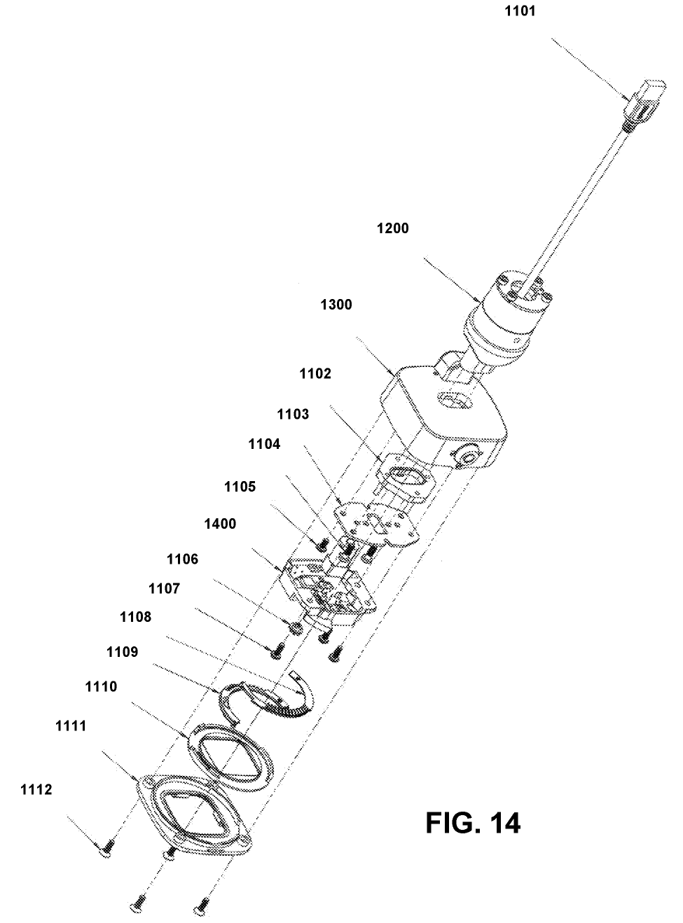

FIG. 11 illustrates an exploded view of an example docking mount housing assembly 1300. The docking mount 1100 includes the example docking mount housing assembly 1300 of FIG. 11. The docking mount housing assembly 1300 includes a housing 1301 and a locking unit 1302 disposed on a side surface of the housing 1301. The housing 1301 has a front surface, a back surface separated from the front surface along a first axis, and a side surface that connects the front surface and the back surface. In some embodiments, the front surface is parallel to the back surface, and the side surface is perpendicular to the front surface. The locking unit 1302 includes a lock mandrel and a key lock disposed in a hole in the housing 1301. In some embodiments, an anti-rotation plate 1303 is disposed over the locking unit 1302 and secured with a lock mounting nut 1304. A screw 1306 secures the lock pinion 1305 to the lock mandrel. The pinion 1305 rotates in response to a rotation of the locking unit 1302 using a corresponding key. Detent 1307 can be installed into housing 1301. Detent 1307 can act to retain lock ring 1111 (FIG. 14) in its position unless sufficient force, such as might be generated by the motor or turning of a key in the locking unit, acts to move the lock ring 1111.

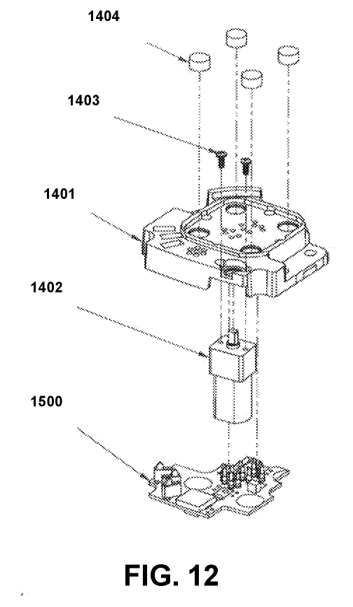

FIG. 12 illustrates an exploded view of an example magnet housing assembly 1400. The docking mount 1100 includes the example magnet housing assembly 1400 of FIG. 12. The magnet housing assembly 1400 comprises a magnet housing 1401, which serves as an internal frame, to which a motor 1402 is installed with screws 1403. A circuit board assembly 1500, mounts into magnet housing 1401 with, for example, heat stakes. The circuit board assembly 1500 is electrically connected to a cable 1101 (FIG. 14). The magnet housing 1401 also receives four magnets 404. In some implementations, the number of magnets 1404 can be different. The magnets can be installed using a variety of methods, including bonding and press-fitting.

FIG. 13 illustrates a view of an example printed circuit board (PCB) assembly 1500, as would be used with the motorized locking mechanism. The docking mount 1100 includes the example PCB assembly 1500 of FIG. 13. The PCB assembly 1500 is used to electronically operate the motorized locking mechanism and comprises several electronic components which may be used for that function. The printed circuit board 1501 incorporates the necessary circuitry to electrically connect and mechanically support the electronic components. The PCB assembly 1500 can include one or more spring pins 1502 which, when enclosure housing 1700 is mated with to docking mount 1100, connect to the electrical interface 1702. Spring pins 1502 can be used to transmit power and/or data to the electronic equipment within enclosure housing 1700. Lock limit switch 1503 can be used to determine whether the lock ring 1110 is rotated to the locked position, thus capturing and retaining the corners of mounting flange 1701 within the central opening in lock ring 1110. Unlock limit switch 1504 can be used to determine whether the lock ring 1110 is rotated to the unlocked position, thus allowing mounting flange 1701 to be inserted or removed from within the central opening in lock ring 1110. Motor ring neutral limit switch 1505 can be used to determine whether the motor ring 1109 is rotated to the neutral position, thus allowing the key ring 1108 to freely move the lock ring 1110 to either the locked or unlocked position. Piezo speaker 1506 can be used to provide alerts to the user including alarms and mode setting feedback. Switch 1507 can be used to allow the user to interact with the device electronics, such as to set a variable operating mode. Switch 1507 can be positioned in the enclosure so that it can be accessed with a paperclip or other tool. Microcontroller 1508 can be used to monitor and interpret signals from the limit switches 1503, 1504, and 1505 and mode switch 1507, and operate the motor 1402 and piezo speaker 1506 accordingly. The motor 1402 can be electrically attached to the circuit board with wires, such as at thru-hole solder points.

Microcontroller 1508, with supporting circuitry and firmware, can be used to monitor the current flowing through motor 1402, detect when the motor is being overloaded, and alert the user accordingly. Microcontroller 1508, with supporting circuitry and firmware, can communicate with the electronic equipment inside the enclosure housing 1700, for example a tablet computer. The electronic equipment inside the enclosure housing 1700, for example a tablet computer, can run a software program designed to receive and authenticate access credentials which, if valid, can communicate with the microcontroller 1508 to operate, either lock or unlock, the motorized locking mechanism. The information communicated between electronic equipment inside enclosure housing 1700 and microcontroller 1508 can be encrypted for security.

FIG. 14 illustrates an exploded view of an example motorized locking mount assembly 1100. The motorized locking mount assembly 1100 is assembled by routing cable 1101 through optional pivoting neck assembly 1200, through docking mount housing assembly 1300, through neck plate 1102, through internal dock plate 1103, and attaching it electrically to the provided terminals on printed circuit board 1501. The neck plate 1102 and internal dock plate 1103 are disposed between a front surface and a back surface of the housing 1301. The pivoting neck assembly 1200, docking mount housing assembly 1300, neck plate 1102, and internal dock plate 1103 include passages to receive the cable 1101. The cable 1101 can transmit power and/or signals to electronic equipment. The internal dock plate 1103 attaches with screws 1104 to ball halves 1202. The ball halves 1202 can be part of a pivoting neck assembly 1200. Additionally, internal dock plate 1103 can attach to docking mount housing 1301 with screw 1105. A circuit board 1501 at the end of cable 1101 mounts into a magnet housing 1401 with, for example, heat stakes, as part of magnet housing assembly 1400. The magnet housing assembly 1400 secures to docking mount housing 1301, part of docking mount housing assembly 1300, with, for example three additional screws 1107. The three additional screws 1107 pass through magnet housing 1401, part of magnet housing assembly 1400, internal dock plate 1103, and into docking mount housing 1301, part of docking mount assembly 1300, capturing neck plate 1102 in the process. A motor pinion 1106, used to drive motor ring 1109, is mounted to the output shaft of gear motor 1402, for example by press-fit. Key ring 1108 and motor ring 1109 are lubricated, with grease for example, and seated into a receiving groove in lock plate 1110. The lock plate 1110, key ring 1109, and motor ring 1109 are placed into the assembly with gear teeth on the key ring 1108 meshing with gear teeth on the key pinion 1305 and the gear teeth on the motor ring 1109 meshing with gear teeth on the motor pinion 1106. The front surface of the motorized locking mount assembly 1100, for example, a mount cover 1111, is placed over the lock plate 1110 and secured, for example, with four screws 1112. Components of the motorized docking mount assembly 1100 may be assembled in an order different from that described above. In some implementations, different fasteners may be used.

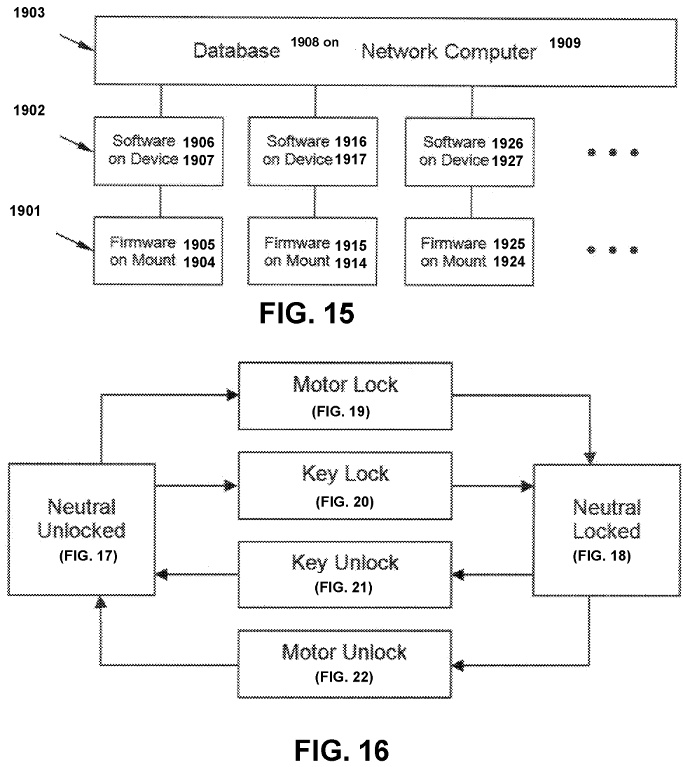

FIG. 15 illustrates an example network topology in which a motorized locking mount may reside. An example network topology may include three layers. A first layer of the example network topology can be the equipment layer 1901, consisting of one or more mounts 1904, 1914, 1924, with firmware 1905, 1915, 1925 residing on microcontrollers, such as example microcontroller 1508, in each of those mounts. The firmware on these various mounts may be the same or may be different. The firmware may be specialized, for example to support and communicate with different device models 1907, 1917, 1927. The mounts 1904, 1914, 1924 may be the same or different, for example to support and transmit different levels of recharge voltage and power as may be required by different device models 1907, 1917, 1927.

A second layer of the example network topology can be the device layer 1902, consisting of one or more devices 1907, 1917, 1927, with software application 1906, 1916, 1926 operating on those devices 1907, 1917, 1927. The devices 1907, 1917, 1927 may, for example, be tablet computers. The devices 1907, 1917, 1927 may be the same or different, such as different models of tablet computer. The software application 1906, 1916, 1926 may be the same or different, such as different versions of the software application 1906, 1916, 1926 designed to operate on different models of tablet computer.

A third layer of the example network topology can be the network layer 1903, consisting of a database application 1908 operating on a networked computer 1909. The networked computer 1909 is connected to the devices 1907, 1917, 927 by a network, such as the Internet, and communicates with those devices 907, 917, 1927 over either wireless or wired networks, or a combination of wireless and wired networks. One aspect of the software application 1906, 1916, 1926 can be that it is compatible, for the device 1907, 1917, 1927 on which it resides, to communicate with the database application 1908 on the networked computer 11909. This allows the database application 1908 on the networked computer 1909 to administer and collect information from a large installed network of devices 1907, 1917, 1927 and mounts 1904, 1914, 1924 to a single, central location, independent of the specific device, for example model of tablet computer, which may be installed. The connection of multiple mounts 1904, 1914, 1924 using a network allows those mounts to be centrally administered. Some examples of network-supported activities may include logging of access data, such as when the mount was locked or unlocked and by which user, whether a device 1907, 1917, 1927 is docked in a mount, and if so which physical mount and therefore geographic location, if that location is registered to the mount it is docked in, and whether the device is receiving power from that mount. Additional examples of network-supported activities may include the provisioning of user accounts and management of passwords for those accounts, the remote activation of a motorized docking mount 1904, 1914, 1924, and the updating of software 1906, 1916, 1926 and firmware 1905, 1915, 1925.

A software application 1906, 1916, 1926 may also communicate information to the networked computer 1909 that may be useful in the monitoring of the devices 1907, 1917, 1927 themselves, independent of the mounts 1904, 1914, 1924. Such information may include what other software applications are running and the charge level of the device batteries. A software application 1906, 1916, 1926 may also communicate information to the networked computer 1909 that may be useful in the monitoring of the environment in which devices 1907, 1917, 1927 are deployed, such as whether a person is standing in front of the device, whether that person is looking at the device, whether that person is using the device, and how often people stand in front of, look at, and use the device over a period of time.

The software application 1906, 1916, 1926 can be designed to receive as input an access credential which may, for example consist of one or more passwords, PINs (personal identification number), biometric information items such as fingerprints, and/or images such as barcodes, QR codes, or other images. The software application can be designed to authenticate the access credential or credentials, and if valid, communicate with the microprocessor 1508 in the attached mount 1904, 11914, 924 to operate, either lock or unlock, the motorized locking mechanism in that mount 1904, 1914, 1924. Such barcode, QR code, or other image may be printed on a piece of paper or another object or may be displayed digitally, such as on the screen of a tablet or cell phone. The software application 1906, 1916, 1926 can be designed to recognize a radio signal to trigger operation of the motorized locking mechanism. The software application 1906, 1916, 1926 can be designed to recognize a command from a networked computer 1909 to trigger operation of the motorized locking mechanism.

An administration interface can be provided as part of the database 1908 operating on networked computer 1909 that allows the collected data and administrative functions to be accessed from any other computer or device also connected to that network, including devices 1907, 1917, 1927.

FIG. 16 diagrams the locking and unlocking sequences of an example motorized locking mechanism. An important and advantageous aspect of the mechanism is that either the motor or the key may be used to both lock and unlock the mechanism. This allows the mechanism to be controlled by software via the motor or overridden manually using a key. A manual override for the mechanism allows it to be used in scenarios where power is not available or where a less technological solution is desired. To allow two modes of actuation for the same mechanism, the example motorized locking mechanism employs a neutral state for each method of actuation. In the example motorized locking mechanism, either the motor ring 1109 or key ring 1108 can be driven to move the lock ring 1110 between the locked and unlocked positions. When either the motor ring 1109 or key ring 1108 is in its neutral position, centered between lock and unlock, an annular slot in the lock ring allows the lock ring to move past the stationary ring, i.e. motor ring 1109 or key ring 1108, while the other ring, i.e. key ring 1108 or motor ring 1109, is driven to actuate the mechanism. If the annular slot were not present, or if the rings did not start each operation in their neutral, centered position, the motor ring 1109 and key ring 1108 would be interlocked and would interfere with each other’s movement in the mechanism. While the manual force of a key being turned in the locking unit 1302 is able to overcome the motor 1402, and this is useful for scenarios where power fails or the motor ring 1109 jams, the motor 1402 is not able to overcome the locking unit 1302 because the locking unit 1302 can only be turned with a key.

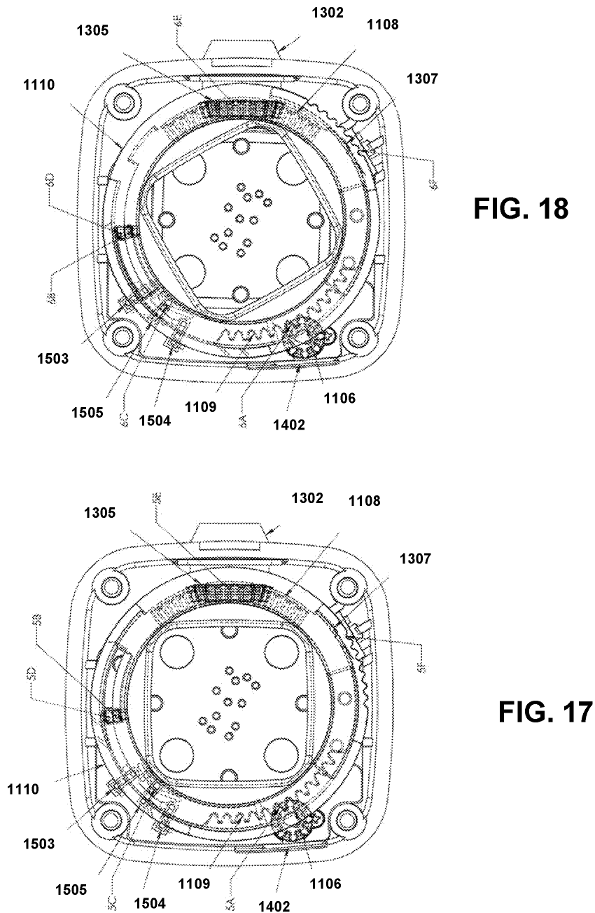

The diagram in FIG. 17 shows the sequence of movements which the mechanism employs to move between unlocked and locked positions. So that the two methods of driving the mechanism, i.e. motor and key, do not interfere with each other, each sequence begins and ends in a neutral position, with both rings, i.e. key ring 1108 and motor ring 1109, centered. In the diagram, locking operations move from left to right and unlocking operations move from right to left.

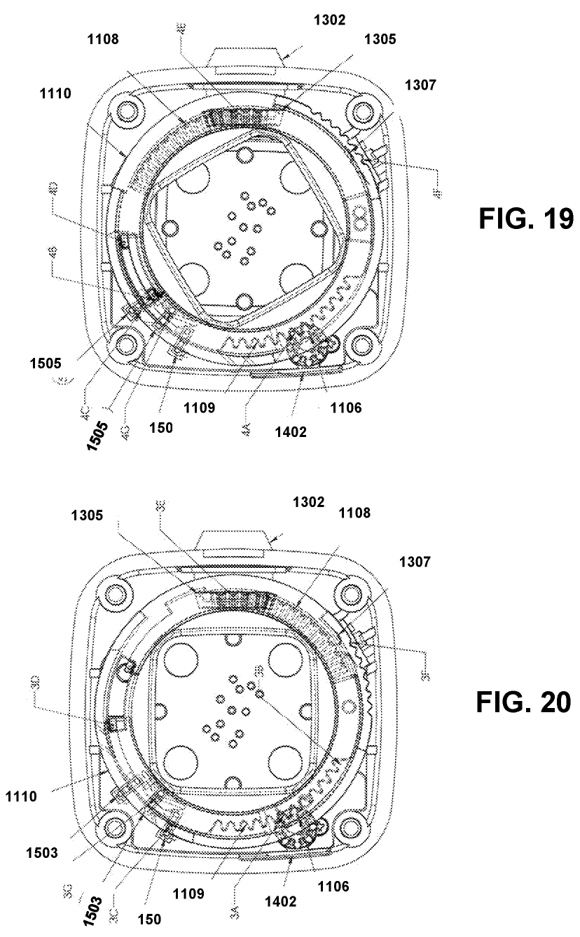

From the “unlocked neutral position” (FIG. 17), the mechanism can be locked with either the motor 1402 or key-driven locking unit 1302. If the mechanism is locked by the motor 1402, the motor pinion 1106 is driven in a clockwise direction, driving the motor ring 1109 in a counter-clockwise direction, which pushes against the lock ring 1110 to rotate the lock ring 1110 into the locked position, as shown in FIG. 19. When the lock ring 1110 reaches the locked position signaled by a limit switch, the motor pinion 1106 is then driven in a counter-clockwise direction, returning the motor ring 1109 to its neutral position. When the motor ring 1109 reaches its neutral position signaled by a limit switch the motor is stopped. The mechanism is now in the “locked neutral position,” as shown in FIG. 18.

If the mechanism is locked using a key in the locking unit 1302, the user inserts a key and turns it clockwise to the locked position. This turns pinion 1305 in a clockwise direction, which drives the key ring 1108 in a counter-clockwise direction, which pushes against the lock ring 1110 to rotate the lock ring into the locked position, as shown in FIG. 19. When the lock ring 1110 reaches the locked position, a stop on the key pinion prevents the user from turning the key further. To enable motor-driven unlocking, the user then turns the key counter-clockwise to the center position. This turns pinion 1305 in a counter-clockwise direction, which drives the key ring 1108 in a clockwise direction, which returns the key ring 1108 to its neutral position. A slot in the keyway of locking unit 1302 only allows the key to be removed when it is rotated to the center position, ensuring that the key ring 1109 is in its neutral position when the key is removed. When the key aligns with the slot in the locking unit 1302, the key ring 1109 is in its neutral position and the key can be removed. The mechanism is now in the “locked neutral position,” as shown in FIG. 18.

From the “locked neutral position” (FIG. 18), the mechanism can be unlocked with either the motor 1402 or key-driven locking unit 1302. If the mechanism is unlocked by the motor 1402, the motor pinion 1106 is driven in a counter-clockwise direction, driving the motor ring 1109 in a clockwise direction, which pushes against the lock ring 1110 to rotate it into the unlocked position, as shown in FIG. 20. When the lock ring 1110 reaches the unlocked position signaled by a limit switch, the motor pinion 1106 is then driven in a clockwise direction, returning the motor ring 1109 to its neutral position. When the motor ring 1109 reaches its neutral position signaled by a limit switch the motor is stopped. The mechanism is now in the “unlocked neutral position,” as shown in FIG. 17.

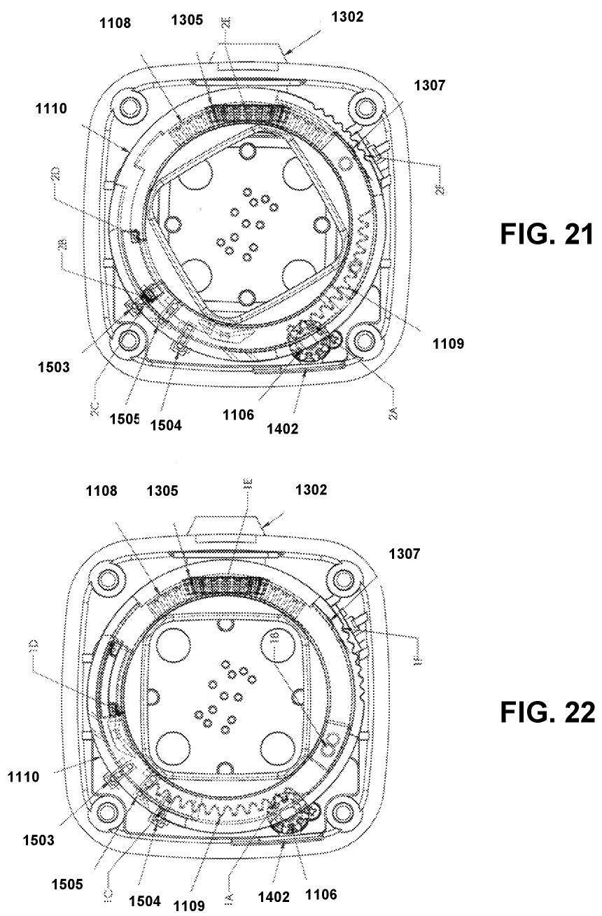

If the mechanism is unlocked using a key in the locking unit 1302, the user inserts a key and turns it counter-clockwise to the unlocked position. This turns pinion 1305 in a counter-clockwise direction, which drives the key ring 108 in a clockwise direction, which pushes against the lock ring 1110 to rotate it into the unlocked position, as shown in FIG. 21. When the lock ring 1110 reaches the unlocked position, a stop on the key pinion prevents the user from turning the key further. To enable motor-driven locking, the user then turns the key clockwise to the center position. This turns pinion 1305 in a clockwise direction, which drives the key ring 1108 in a counter-clockwise direction, which returns the key ring 1108 to its neutral position. A slot in the keyway of locking unit 1302 only allows the key to be removed when it is rotated to the center position, ensuring that the key ring 1109 is in its neutral position when the key is removed. When the key aligns with the slot in the locking unit 1302, the key ring 1109 is in its neutral position and the key can be removed. The mechanism is now in the “unlocked neutral state,” as shown in FIG. 21.

FIG. 17 illustrates an example detailed view of an example motorized locking mechanism. The view in FIG. 17 shows the mechanism in the unlocked neutral position. When the locking mechanism is in this position the enclosure housing 1700 can be freely removed from and mated to the docking mount 1100. In FIG. 17, Motor ring 1109 is shown in its centered, neutral position, with limit switch 1505 rising into pocket 5C in motor ring 1109. The teeth of motor ring 1109 are centered on motor pinion 1106 at location 5A, and the teeth of key pinion 1305 are centered on the meshing teeth of key ring 1108 at location 5E. The key ring drive finger 5B and motor ring drive finger 5D are both against the left inside edge of the lock ring slot. In this configuration, the lock ring 1110 is free to rotate in a counter-clockwise direction to the locked position. The lock ring detent 3107 holds the lock ring 1110 in a static position by pressing into a groove at position 5F.

FIG. 18 illustrates an example detailed view of an example motorized locking mechanism. The view in FIG. 18 shows the mechanism in the locked neutral position. When the enclosure housing 1700 is mated to the docking mount 1100 and the locking mechanism is rotated to this position, the corners of the mounting plate 1702 are captured to the docking mount 1100 by the lock ring 1110. The mounting plate 1702 can be affixed to, or incorporated in, a surface of the enclosure housing 1700, and thus the enclosure housing 1700 is retained to the docking mount 100. The docking mount 1100 can be optionally mounted to a pivot joint 1200 and/or mounting post 1600 and secured to a fixed surface, such as a heavy object, floor, counter, table, wall, pole, or other fixed surface or object. When the mounting plate 1702 is captured by the lock ring 1110, and thus the enclosure housing 1700 captured to the docking mount 1100, the enclosure housing 11700 becomes physically secured to the surface or object to which the docking mount 100 and, alternately pivot joint 1200 and mounting post 1600 is secured to. In FIG. 18, Motor ring 1109 is shown in its centered, neutral position, with limit switch 1505 rising into pocket 6C in motor ring 1109. The teeth of motor ring 1109 are centered on motor pinion 1106 at location 6A, and the teeth of key pinion 1305 are centered on the meshing teeth of key ring 1108 at location 5E. The key ring drive finger 6B and motor ring drive finger 6D are both against the right inside edge of the lock ring slot. In this configuration, the lock ring 1110 is free to rotate in a clockwise direction to the unlocked position. The lock ring detent 1307 holds the lock ring 1110 in a static position by pressing into a groove at position 6F.

FIG. 19 illustrates an example detailed view of an example motorized locking mechanism. The view in FIG. 19 shows the mechanism in the position it arrives at when it has been locked by the locking unit 1302. To reach this position, starting from the neutral unlocked position (FIG. 17) a key is inserted into locking unit 1302 and turned clockwise. Locking unit 1302 turns key pinion 1305 in a clockwise direction. The teeth of key pinion 1305 mesh with the teeth of key ring 1108 at location 4E, driving key ring 1108 counter-clockwise within its groove in lock ring 1110. A finger extending from key ring 1108 pushes against lock ring 1110 at location 4B. If lock ring 1110 starts in the unlocked position, the force of the finger of key ring 1108 pushing against lock ring 1110 at location 4B drives the lock ring 1110 counter-clockwise to the locked position, as shown in FIG. 19. As the key ring 1108 pushes the lock ring 1110, the lock ring detent 1307 moves over a series of detent grooves at location 4F. When the lock ring 1110 reaches the locked position, feature 4C on the lock ring 1110 acts to depress limit switch 1503. The microcontroller 1508 can detect the state change of limit switch 5103 and recognize that the lock ring is in the locked position. While the lock ring moves, motor ring 1109 is held stationary, as it is meshed at location 4A with stationary motor pinion 1106, attached to motor 1402. If, for some reason, the motor ring 1109 is not in its neutral position when the locking unit 1302 is turned with a key, the motor gearing may be back-driven to allow the mechanism to be moved, even without power or control of the motor. When the lock ring reaches the locked position, as shown in FIG. 19, the lock ring detent 1307 holds it in place while the key ring 1109 is returned to the neutral position (FIG. 18). The locking unit 1302 may incorporate a feature, such as a notch, which only allows the key to be removed when the locking unit 1302 is in its neutral position.

FIG. 20 illustrates an example detailed view of an example motorized locking mechanism. The view in FIG. 20 shows the mechanism in the position it arrives at when it has been unlocked by the key. To reach this position, starting from the neutral locked position (FIG. 18) a key is inserted into locking unit 1302 and turned counter-clockwise. Locking unit 1302 turns key pinion 1305 in a counter-clockwise direction. The teeth of key pinion 1305 mesh with the teeth of key ring 1108 at location 3E, driving key ring 1108 counter-clockwise within its groove in lock ring 1110. A finger extending from key ring 1108 pushes against lock ring 1110 at location 3B. If lock ring 1110 starts in the locked position, the force of the finger of key ring 1108 pushing against lock ring 1110 at location 3B drives the lock ring 1110 clockwise to the unlocked position, as shown in FIG. 19. As the key ring 108 pushes the lock ring 11110, the lock ring detent 1307 moves over a series of detent grooves at location 3F. When the lock ring 1110 reaches the unlocked position, feature 3C on the lock ring 1110 acts to depress limit switch 1504. The microcontroller 1508 can detect the state change of limit switch 1504 and recognize that the lock ring is in the unlocked position. While the lock ring moves, motor ring 1109 is held stationary, as it is meshed at location 3A with stationary motor pinion 1106, attached to motor 1402. If, for some reason, the motor ring 1109 is not in its neutral position when the locking unit 1302 is turned with a key, the motor gearing may be back-driven to allow the mechanism to be moved, even without power or control of the motor. When the lock ring reaches the unlocked position, as shown in FIG. 20, the lock ring detent 1307 holds it in place while the key ring 1109 is returned to the neutral position (FIG. 17). The locking unit 1302 may incorporate a feature, such as a notch, which only allows the key to be removed when the locking unit 1302 is in its neutral position.

FIG. 21 illustrates an example detailed view of an example motorized locking mechanism. The view in FIG. 21 shows the mechanism in the position it arrives at when it has been locked by the motor 1402. To reach this position, starting from the neutral unlocked position (FIG. 17) motor 1402 turns motor pinion 1106 in a clockwise direction. The teeth of motor pinion 1106 mesh with the teeth of motor ring 1109 at location 2A, driving motor ring 1109 clockwise within its groove in lock ring 1110. A finger extending from motor ring 1109 pushes against lock ring 1110 at location 2B. If lock ring 1110 is in the unlocked position, the force of the finger of motor ring 1109 pushing against lock ring 1110 at location 2B drives the lock ring 1110 to the locked position, as shown in FIG. 21. As the motor ring 1109 pushes the lock ring 1110, the lock ring detent 1307 moves over a series of detent grooves at location 2F. When the lock ring 1110 reaches the locked position, feature 2C on the lock ring 1110 acts to depress limit switch 1503. The microcontroller 1508 can detect the state change of limit switch 1503 and stop the rotation of the motor 4102. While the lock ring moves, key ring 1108 is held stationary, as it is meshed at location 1E with stationary key pinion 1305, attached to key lock 1302. When the lock ring reaches the locked position, as shown in FIG. 21, the lock ring detent 1307 holds it in place while the motor ring 1109 returns to the neutral locked position (FIG. 18).

FIG. 22 illustrates an example detailed view of an example motorized locking mechanism. The view in FIG. 22 shows the mechanism in the position it arrives at when it has been unlocked by the motor. To reach this position, starting from the neutral locked position (FIG. 18) motor 1402 turns motor pinion 1106 in a counter-clockwise direction. The teeth of motor pinion 1106 mesh with the teeth of motor ring 1109 at location 1A, driving motor ring 1109 clockwise within its groove in lock ring 1110. A finger extending from motor ring 1109 pushes against lock ring 1110 at location 1B. If lock ring 1110 starts in the locked position, the force of the finger of motor ring 1109 pushing against lock ring 1110 at location 1B drives the lock ring 1110 to the open position, as shown in FIG. 20. As the motor ring 1109 pushes the lock ring 1110, the lock ring detent 1307 moves over a series of detent grooves at location 1F. When the lock ring 1110 reaches the open position, feature 1C on the lock ring 1110 acts to depress limit switch 1504. The microcontroller 1508 can detect the state change of limit switch 1504 and stop the rotation of the motor 1402. While the lock ring moves, key ring 1108 is held stationary, as it is meshed at location 1E with stationary key pinion 1305, attached to key lock 1302. When the lock ring reaches the open position, as shown in FIG. 20, the lock ring detent 1307 holds it in place while the motor ring 1109 is returned to the neutral position (FIG. 17).

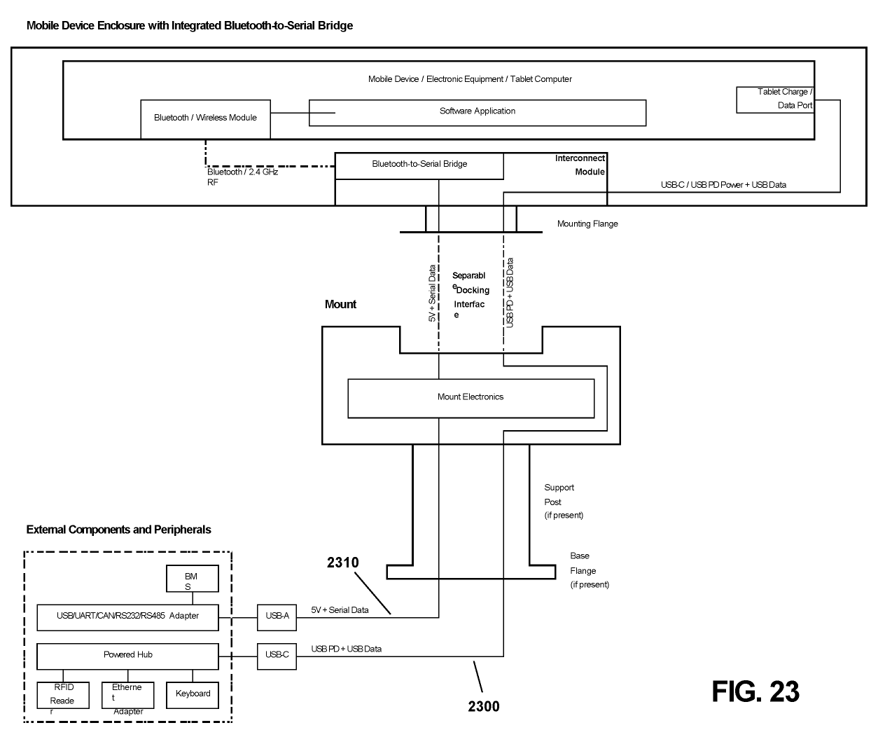

FIG. 23 is a wire diagram describing the components and communication flows of the disclosed system in schematic form. Two distinct channels for power and data communication are described.

The first channel 2300 provides for power and peripheral connectivity to the mobile device. This channel bypasses the mount electronics and creates a direct wired connection between the primary charge/data port on the tablet and the associated cable, nominally terminating in a USB-C plug extending from the mount. As a direct connection to the mobile device, the first channel is suitable for connecting power supplies as well as many common peripherals, including ethernet adapters, keyboards, barcode readers, printers, RFID readers, pointing devices, hubs, and the like.

The second channel 2310 incorporates a Bluetooth-to-Serial bridge physically located in the device enclosure and paired with the mobile device. Such Bluetooth pairing can be made and managed b) the software application running on the mobile device. Serial data can thus be bridged from the wired connection at the interface of the mount and device enclosure directly to the software application with which communication is desired. The second channel receives power independently from the first channel, such power being delivered by a distinct cable, nominally terminating in a USB-A plug, extending from the mount. The second channel provides power to the mount electronics and to the Bluetooth-to-Serial bridge, and facilitates communication between the mount and the software application which communicates with the mount. Such communication includes sending unlock commands to the mount and receiving data, including identifying data, status data, and other data, from the mount. The second channel can also optionally facilitate the further connection of additional specialized equipment, with various inputs as the software application may require, and support the communication of that equipment with the software application over the established Bluetooth-to-Serial bridge.

### Computer System

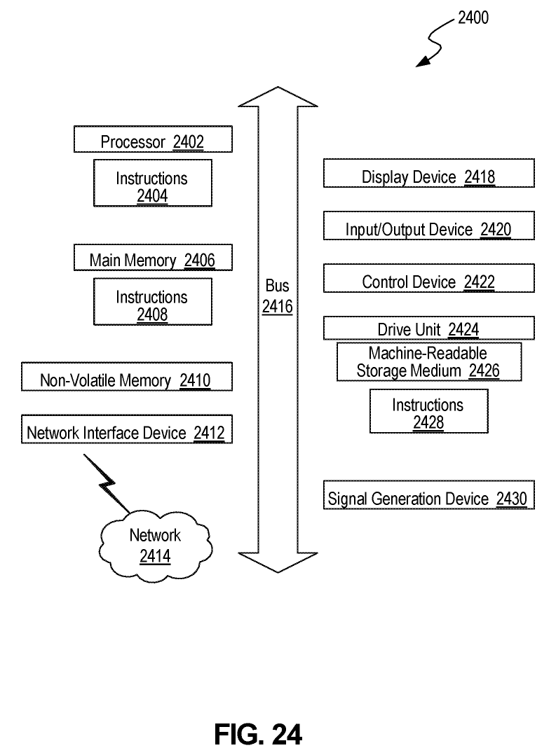

FIG. 24 is a block diagram that illustrates an example of a computer system 2400 in which at least some operations described herein can be implemented. As shown, the computer system 2400 can include: one or more processors 2402, main memory 2406, non-volatile memory 2410, a network interface device 2412, a video display device 2418, an input/output device 2420, a control device 2422, e.g. keyboard and pointing device, a drive unit 2424 that includes a machine-readable (storage) medium 2426, and a signal generation device 2430 that are communicatively connected to a bus 2416. The bus 2416 represents one or more physical buses and/or point-to-point connections that are connected by appropriate bridges, adapters, or controllers. Various common components, e.g. cache memory, are omitted from FIG. 24 for brevity. Instead, the computer system 2400 is intended to illustrate a hardware device on which components illustrated or described relative to the examples of the figures and any other components described in this specification can be implemented.

The computer system 2400 can take any suitable physical form. For example, the computing system 2400 can share a similar architecture as that of a server computer, personal computer (PC), tablet computer, mobile telephone, game console, music player, wearable electronic device, network-connected (“smart”) device, e.g. a television or home assistant device, AR/VR systems, e.g. head-mounted display, or any electronic device capable of executing a set of instructions that specify actions to be taken by the computing system 2400. In some implementations, the computer system 2400 can be an embedded computer system, a system-on-chip (SOC), a single-board computer system (SBC), or a distributed system such as a mesh of computer systems, or it can include one or more cloud components in one or more networks. Where appropriate, one or more computer systems 1000 can perform operations in real time, in near real time, or in batch mode.

The network interface device 2412 enables the computing system 2400 to mediate data in a network 2414 with an entity that is external to the computing system 2400 through any communication protocol supported by the computing system 2400 and the external entity. Examples of the network interface device 2412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory, e.g. main memory 2406, non-volatile memory 2410, machine-readable medium 2426, can be local, remote, or distributed. Although shown as a single medium, the machine-readable medium 2426 can include multiple media, e.g. a centralized/distributed database and/or associated caches and servers, that store one or more sets of instructions 2428. The machine-readable medium 2426 can include any medium that is capable of storing, encoding, or carrying a set of instructions for execution by the computing system 2400. The machine-readable medium 2426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 2410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions, e.g. instructions 2404, 2408, 2428, set at various times in various memory and storage devices in computing devices. When read and executed by the processor 2402, the instructions cause the computing system 2400 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. An apparatus, comprising:
a mount configured to receive and support a device enclosure;
a device enclosure configured to receive an electronic mobile device and to removably couple to the mount at a mounting interface;
a wireless-to-serial bridge disposed within a mounting portion of the device enclosure and comprising a wireless radio and a microcontroller configured to convert between a wireless protocol and a wired serial protocol;
a first electrical channel comprising a first cable routed through the mount and across the mounting interface to the device enclosure and a connector configured to couple directly to a primary power/data port of the mobile device to provide device charging and device-level data without intermediate consumption by the mount or the wireless-to-serial bridge; and
a second electrical channel comprising a second cable routed through the mount to mount electronics including a microcontroller and a wired serial port, the second cable further providing power across the mounting interface to the wireless-to-serial bridge disposed within the device enclosure;
wherein the wireless-to-serial bridge is configured to exchange, via the wired serial port and the second electrical channel, serial data with the mount electronics and to exchange, via the wireless protocol, data with an application executing on the mobile device, such that the application can programmatically identify the mount to which the device enclosure is docked.

2. The apparatus of claim 1, wherein the wireless protocol is Bluetooth and the wireless-to-serial bridge is configured to establish a bonded pairing with a single associated mobile device, the bonded pairing being maintainable to allow reconnection using retained encryption keys.

3. The apparatus of claim 2, wherein the wireless-to-serial bridge comprises:
a pairing actuator located within the mounting portion of the device enclosure such that, when the mobile device is secured within the device enclosure, the actuator is physically inaccessible.

4. The apparatus of claim 1, wherein the device enclosure comprises an interconnect module comprising:
a board-to-board connector that conducts signals between an interface board adjacent the mounting interface and the wireless-to-serial bridge; and
an internal cable terminating at a device connector selected from USB-C, Micro-USB, or a proprietary connector for plugging into the mobile device.

5. The apparatus of claim 1, wherein the mount electronics comprises:
a microcontroller storing a mount unique identifier (UDID) accessible via the wired serial port, and the application executing on the mobile device is configured to receive the UDID through the wireless-to-serial bridge and to map the UDID to a registered mount identity.

6. The apparatus of claim 1, wherein the mount further comprises a planar rotating locking mechanism having:
a lock plate configured to capture corners of a mounting plate of the device enclosure;
a motor ring driven by a motor pinion mounted to a motor; and
a key ring driven by a key pinion mounted to a key-operated locking unit;
the motor ring and key ring being configured for noninterfering actuation by employing neutral positions and an annular slot permitting the lock plate to be driven by either ring while the other ring remains stationary.

7. The apparatus of claim 6, wherein the mount includes limit switches to indicate at least one of:
a locked position of the lock plate, an unlocked position of the lock plate, and a neutral position of the motor ring.

8. The apparatus of claim 1, wherein the mounting interface comprises:
magnets arranged to draw a mounting plate of the device enclosure into alignment such that electrical contacts of the first electrical channel and the second electrical channel are engaged in any of four primary orientations rotated in substantially 90-degree increments.

9. The apparatus of claim 1, wherein the second electrical channel comprises:
a USB-A connection coupled to a hardware converter and/or software emulator implementing a serial communications port accessible by the application via the wireless-to-serial bridge.

10. The apparatus of claim 1, wherein the first electrical channel is compliant with USB-C power delivery negotiation between a power source and the mobile device by directly coupling the power source to the mobile device without sharing power with the mount electronics or the wireless-to-serial bridge.

11. The apparatus of claim 1, wherein the wireless-to-serial bridge is powered only when the device enclosure is docked to the mount.

12. The apparatus of claim 1, wherein the application is configured to transmit an electronic command via the wireless-to-serial bridge to the mount electronics to actuate the motor to lock or unlock the device enclosure responsive to authentication of a user credential.

13. The apparatus of claim 12, wherein the user credential comprises at least one of:
a password, a PIN, biometric information, an image-based code, or a command received from a networked administrator system.

14. The apparatus of claim 1 wherein the mount electronics are configured to forward data between peripheral devices coupled to the second electrical channel and the application via the wireless-to-serial bridge.

15. The apparatus of claim 1, wherein the mounting interface comprises:
patterned contact pads arranged symmetrically to support electrical engagement in portrait, landscape, inverted portrait, and inverted landscape orientations without a wiping interface.

16. The apparatus of claim 1, wherein the wireless‑to‑serial bridge encapsulates inbound serial data from the mount microcontroller into Bluetooth packets and parses inbound Bluetooth packets into serial data for the mount microcontroller.

17. The apparatus of claim 1, wherein the mobile electronic device is paired only with the wireless‑to‑serial bridge disposed in its own device enclosure, thereby avoiding pairings with multiple mounts.

18. The apparatus of claim 1, wherein the mount microcontroller forwards communication from peripheral devices connected to the second cable to the application via the wireless‑to‑serial bridge.

19. The apparatus of claim 1, wherein the application identifies the docked mount by matching the UDID received via the wireless‑to‑serial bridge to entries in a database or lookup table accessible to the application.

20. The apparatus of claim 1, wherein the first cable is dedicated to the mobile electronic device charging and data and is electrically isolated from power provided to the mount and the wireless‑to‑serial bridge.

21. The apparatus of claim 1, wherein the mount comprises:
a pivot joint or support structure and the second cable routes through the mount to a mount board that fans out connections to the spring‑loaded contacts at the mount–enclosure interface.

22. A method of providing secure, identifiable communication between a dock mount and a mobile electronic device, the method comprising:
disposing a wireless-to-serial bridge within a mounting portion of a device enclosure configured to receive the mobile electronic device;
docking the device enclosure to a mount having a microcontroller and a serial interface;
supplying power and serial data from the mount to the wireless-to-serial bridge over a first electrical path across a mount–enclosure interface;
supplying charging power and device-level data directly to the mobile electronic device over a second electrical path separate from the first electrical path;
wirelessly pairing the mobile electronic device with the wireless-to-serial bridge;
converting, at the wireless-to-serial bridge, data between wireless packets exchanged with the mobile electronic device and serial data exchanged with the mount microcontroller; and
providing, from the mount microcontroller to the mobile electronic device via the wireless-to-serial bridge, a unique device identifier that enables an application running on the mobile electronic device to definitively identify the mount to which the device enclosure is docked.

23. The method of claim 22, further comprising:
bonding the wireless pairing with encryption keys such that only the mobile electronic device within the device enclosure can communicate with the wireless‑to‑serial bridge.

24. The method of claim 22, further comprising:
preventing access to a physical pairing actuator of the wireless‑to‑serial bridge by securing the mobile electronic device within the device enclosure.

25. The method of claim 22, further comprising:
requiring user credentials to clear bonding via the application or via mobile device settings.

26. The method of claim 22, further comprising:
routing charging power and device‑level data through a USB‑C connection to the mobile electronic device and routing serial data through a COM‑port emulation over a USB‑A connection to the wireless‑to‑serial bridge.

27. The method of claim 22, further comprising:
operating a motorized lock to secure the device enclosure to the mount while maintaining the electrical interface for the first and second power/data channels.

28. The method of claim 22, further comprising:
automatically reestablishing the wireless connection upon dock/undock events using retained pairing keys.

29. A docking apparatus comprising:
a docking mount having a housing with a front surface, a back surface, and a side surface, the docking mount configured to removably receive and secure a device enclosure;
a locking mechanism disposed within the housing, the locking mechanism comprising:
a lock plate configured to rotate about a first axis to capture and release a mounting plate of the device enclosure,
a motor ring configured to be driven by a motor pinion mounted to a motor disposed on a second axis parallel to and offset from the first axis,
a key ring configured to be driven by a key pinion mounted to a locking unit disposed on an axis perpendicular to the first axis, and
an annular slot in the lock plate arranged such that, when either the motor ring or the key ring is in a neutral centered position, the other ring can drive the lock plate without interference;
an electrical interface at a mount–enclosure interface comprising spring-loaded contacts on the docking mount arranged to mate with conductive pads on an interface board of the device enclosure;
a first power/data channel configured to provide a direct, device-level power and data connection to a primary charge/data port of electronic equipment housed in the device enclosure, independent of the docking mount electronics; and
a second power/data channel configured to provide power to the docking mount electronics and serial data connectivity between a microcontroller of the docking mount and a wireless-to-serial bridge disposed within a mounting portion of the device enclosure;
wherein the wireless-to-serial bridge, when paired with the electronic equipment, wirelessly exchanges data with an application running on the electronic equipment and converts data to and from serial data communicated over the second power/data channel; and
wherein the mounting interface includes alignment lead-ins and magnetically assisted attraction to facilitate tight mechanical coupling, reliable electrical contact, and docking in any of four primary orientations.

30. The docking apparatus of claim 29, wherein the wireless-to-serial bridge comprises:
a Bluetooth-to-serial bridge configured for bonded pairing with the electronic equipment.

31. The docking apparatus of claim 30, wherein the Bluetooth-to-serial bridge is configured to bond with only one device at a time and to automatically reestablish communication using retained encryption keys.

32. The docking apparatus of claim 30, wherein the Bluetooth-to-serial bridge comprises:
a physical pairing actuator rendered inaccessible when the electronic equipment is secured within the device enclosure.

33. The docking apparatus of claim 29, wherein the first power/data channel comprises:
a USB-C connection supporting USB-C power delivery negotiation directly between a power source and the electronic equipment.

34. The docking apparatus of claim 29, wherein the second power/data channel comprises:
a USB-A connection implementing a COM port via hardware converters and/or software emulation.

35. The docking apparatus of claim 29, wherein the docking mount further comprises:
magnets disposed to attract the mounting plate into alignment and support at least a portion of the weight of the device enclosure.

36. The docking apparatus of claim 29, wherein the electrical interface comprises:
patterned conductive pads and spring-loaded contacts arranged to maintain correct power and data routing across portrait, landscape, inverted portrait, and inverted landscape orientations.

37. The docking apparatus of claim 29, wherein the locking mechanism further comprises:
limit switches configured to signal locked, unlocked, and ring-neutral positions to the microcontroller.

38. The docking apparatus of claim 29, wherein the motorized component is disposed on the second axis parallel to and offset from the first axis, and the key-operated locking unit is disposed on an axis perpendicular to the first axis.

39. The docking apparatus of claim 29, wherein the housing encloses the lock plate, motor, locking unit, mechanism, and associated electronics in a planar rotating configuration with overlapping rings whose movements do not interfere.

40. A system comprising:
a docking mount comprising:
a motor, a motor pinion, and a motor ring arranged to rotate a lock plate about a first axis,
a key-operated locking unit, a lock pinion, and a key ring arranged to rotate the lock plate about the first axis, and
a microcontroller configured to receive signals from limit switches indicating locked, unlocked, and ring-neutral positions, to control the motor accordingly, and to communicate over a serial interface;
a device enclosure comprising a mounting plate configured to be captured by the lock plate, an interface board having conductive pads arranged to mate with spring-loaded contacts of the docking mount, and a wireless-to-serial bridge disposed within a mounting portion of the device enclosure;
a first cable providing a direct power/data connection to a primary charge/data port of a mobile electronic device within the device enclosure; and
a second cable providing power to the docking mount electronics and serial connectivity between the microcontroller and the wireless-to-serial bridge through the mount–enclosure interface;
wherein, when docked, the application running on the mobile electronic device wirelessly pairs with the wireless-to-serial bridge and exchanges serial data with the microcontroller over the second cable, including receiving identifying data associated with the docking mount, and issuing lock/unlock commands to the motorized locking mechanism.

41. The system of claim 40, wherein the microcontroller communicates identifying data, including a unique mount identifier, status data, and power-availability data, to the application via the wireless-to-serial bridge.

42. The system of claim 40, wherein the application is configured to authenticate access credentials and, upon validation, transmit unlock commands to the microcontroller via the wireless-to-serial bridge.

43. The system of claim 40, wherein the wireless-to-serial bridge encapsulates inbound serial data from the microcontroller into wireless packets and parses inbound wireless packets into serial data for the microcontroller.

44. The system of claim 40, wherein magnets at the mount–enclosure interface maintain alignment and permit the electrical interface to function whether or not the locking mechanism is engaged.

45. The system of claim 40, wherein the device enclosure comprises:
alignment lead-ins and guide features configured to progressively tighten the mechanical connection to reduce wobble and improve electrical contact.

46. The system of claim 40, wherein the microcontroller monitors motor current to detect overload conditions and provides alerts via a speaker.

47. A method of securing electronic equipment and providing power and communication through a docking apparatus, the method comprising:
disposing, within a mounting portion of a device enclosure, a wireless-to-serial bridge configured to wirelessly communicate with electronic equipment housed in the device enclosure and to convert between wireless protocol packets and serial data;
providing, at a docking mount, a motorized locking mechanism and a key-driven locking mechanism, each configured to rotate a lock plate about a first axis, and arranging the mechanisms with rings and an annular slot to enable motor or key actuation without interference by placing the non-actuated ring in a neutral position;
docking the device enclosure to the docking mount such that spring-loaded contacts on the docking mount mate with conductive pads on an interface board of the device enclosure;
supplying charging power and device-level data to the electronic equipment over a first power/data channel that directly connects to a primary charge/data port of the electronic equipment and bypasses docking mount electronics;
supplying power to the docking mount electronics and serial data connectivity between a docking mount microcontroller and the wireless-to-serial bridge over a second, separate power/data channel;
wirelessly pairing the electronic equipment with the wireless-to-serial bridge and exchanging, via the bridge, serial data with the docking mount microcontroller including commands to operate the motorized locking mechanism and receiving status and identifying data; and
maintaining reliable electrical connection and mechanical stability across four primary docking orientations using alignment lead-ins and magnetic attraction at the mount–enclosure interface.

48. The method of claim 47, further comprising:
bonding the wireless pairing with encryption keys such that only the electronic equipment housed in the device enclosure communicates with the wireless-to-serial bridge.

49. The method of claim 47, further comprising:
requiring user credentials to initiate motorized unlocking via the application running on the electronic equipment.

50. The method of claim 47, further comprising:
operating the motor to move the motor ring to drive the lock plate while the key ring remains in a neutral centered position, and vice versa for key-driven operation.

51. The method of claim 47, further comprising:
signaling locked and unlocked positions via limit switches, and stopping the motor based on limit-switch state changes.

52. The method of claim 47, further comprising:
maintaining correct power and data routing across four rotational orientations using patterned contact pads and spring-loaded contacts.

53. A device enclosure for electronic equipment comprising:
a rear housing and a mounting plate configured to be captured by a lock plate of a docking mount;
a mounting flange comprising an interface board with conductive pads arranged to mate with spring-loaded contacts of a docking mount across four rotational orientations;
a wireless-to-serial bridge integrated into the mounting flange, the bridge including a wireless radio and a microcontroller configured to translate between wireless protocol messages and serial data;
a board-to-board connector coupling the interface board to an interconnect board;
a first internal cable terminating in a connector configured to directly couple to a primary charge/data port of electronic equipment housed in the device enclosure; and
circuitry arranged such that power and serial data received from the docking mount are routed to the wireless-to-serial bridge, while charging power and device-level data are routed directly to the electronic equipment independently of the docking mount electronics.

54. The device enclosure of claim 53, wherein the wireless-to-serial bridge comprises:
a Bluetooth module with integrated radio and microcontroller and includes a board-accessible switch configured as a pairing button.

55. The device enclosure of claim 53, wherein the board-to-board connector carries a first set of conductors passing charging power and device-level data to the electronic equipment and a second set of conductors delivering power and wired serial communication to the wireless-to-serial bridge.

56. The device enclosure of claim 53, wherein the internal cable terminates in a USB-C connector configured for direct connection to the primary charge/data port of the electronic equipment.

57. The device enclosure of claim 53, wherein the mounting plate is arranged to be captured by a rotating lock plate of the docking mount.

58. The device enclosure of claim 53, wherein the mounting flange is incorporated directly into a housing of the electronic equipment.
